(19) United States
(12) Patent Application Publication
(10) Pub. No.: US 2026/0119093 A1
(43) Pub. Date: Apr. 30, 2026

(54) STORAGE MEDIUM STORING PRINT APPLICATION PROGRAM, CONTROL METHOD, AND INFORMATION PROCESSING APPARATUS

(71) Applicant: CANON KABUSHIKI KAISHA, Tokyo (JP)

(72) Inventor: MASATO KOBAYASHI, Chiba (JP)

(21) Appl. No.: 19/351,518

(22) Filed: Oct. 7, 2025

(30) Foreign Application Priority Data
Oct. 25, 2024 (JP) 2024-188278

(51) Int. Cl. G06F 3/12

(52) U.S. Cl. CPC G06F 3/1231; G06F 3/1205; G06F 3/1285

(57) ABSTRACT

A mechanism that enables a user to use a photo correction function in printing using a standard driver that does not have the photo correction function. A non-transitory computer-readable storage medium storing a print application program, which supports a standard driver that is provided by a provider of an operating system and is built in the operating system in advance, causing a computer to execute a control method including displaying a screen to receive a setting to a photo correction function that is not provided by the standard driver on an information processing apparatus, and causing the information processing apparatus to generate print data that can cause a printing apparatus to execute the photo correction function with the setting received through the screen.

### BACKGROUND

### Field of the Technology

The aspect of the embodiments relates to a storage medium storing a print application program, a control method, and an information processing apparatus.

### Description of the Related Art

There is a known configuration to issue a print instruction to a printing apparatus connected to the host computer while using a printer driver installed in the host computer as control software for the printing apparatus. An OS (Operating System), which is basic software, is installed in the host computer, and the printer driver is configured in accordance with a specification defined by the OS and is called from the OS to operate. On the other hand, a manufacturer that provides a printer can provide a method to instruct the printer to perform printing using the OS by providing a printer driver that conforms to specifications of the OS.

In recent years, Windows (registered trademark) provides a standard class driver (hereinafter, also referred to as a “standard driver”) that can be commonly used among printers provided by different manufacturers. A standard driver is packaged in the OS package, and an arbitrary printing apparatus can be easily usable by connecting to a host computer. Therefore, the standard driver does not require a user to separately install a printer driver that is specific to a model and is suitable for a printer, and thus the convenience of the standard driver is high. The standard driver is able to set a print function according to Print Device Capabilities (hereinafter, also referred to as “PDC”) generated on the basis of information obtained from a connected printer. Thus, the user using the standard driver can set the print function according to the capability of the connected printer even though the user uses one standard driver.

However, since print functions that can be set by the user is limited to functions that can be achieved by the standard driver alone, the user cannot set a print function unique to a manufacturer. In view of this, Japanese Patent Laid-Open No. 2021-33526 (JP2021-33526A, Counterpart of US20210055893A1) discloses a technique to expand a function so as to achieve print functions unique to a manufacturer, such as a color print function, a poster print function, and a bookbinding print function, by using an expansion application associated with the standard driver.

In this regard, functions unique to a manufacturer include, for example, an automatic photo image correction function, a face correction function, and a red-eye correction function, in addition to the color print function and the like mentioned above. Hereinafter, the automatic photo image correction function, the face correction function, the red-eye correction function, and the like are collectively referred to as “photo correction functions”. The automatic photo image correction function analyzes print data and corrects brightness and vividness of the print data in accordance with contents of the print data. The face correction function detects a human face and corrects the face to be bright. The red-eye correction function corrects a phenomenon that eyes of a person become red in photographing to make the eyes of the person have a natural color tone. The automatic photo image correction function, the face correction function, the red-eye correction function, and the like can be applied not only individually but also in combination. With such photo correction functions, the printer can print the print data in a more preferable state as a photograph.

Although the expansion application disclosed in the above publication can save the toner in printing using the standard driver, it cannot achieve the photo correction functions. Therefore, when the photo correction function cannot be used in printing using the standard driver, the user may not cause the printing apparatus to print the print data in a more preferable state as a photograph, and there is a concern that inconvenience is forced.

### SUMMARY

The present disclosure provides a mechanism that enables a user to use a photo correction function in printing using a standard driver that does not have the photo correction function.

Accordingly, an aspect of the embodiments provides a non-transitory computer-readable storage medium storing a print application program, which supports a standard driver that is provided by a provider of an operating system and is built in the operating system in advance, causing a computer to execute a control method including displaying a screen to receive a setting to a photo correction function that is not provided by the standard driver on an information processing apparatus, and causing the information processing apparatus to generate print data that can cause a printing apparatus to execute the photo correction function with the setting received through the screen.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram showing a hardware configuration of a printing system.

FIGS. 2A and 2B are block diagrams illustrating software configurations of a print system in a first embodiment.

FIGS. 3A, 3B, and 3C are views illustrating examples of effects of photo correction functions.

FIGS. 4A and 4B are graphs illustrating an example of a histogram of brightness (Y) values and feature amounts.

FIG. 5A is a graph illustrating examples of contrast adjustment tone curves, and FIG. 5B is a graph illustrating an example of a saturation adjustment weight coefficient.

FIG. 6A is a view illustrating an example of a print setting screen in a first embodiment. FIGS. 6B, 6C, and 6D are views illustrating examples of advanced setting screens in the first embodiment.

FIG. 7 is a flowchart illustrating a PDC editing process performed by a print function expansion unit of an expansion application in the first embodiment.

FIG. 8 is a view illustrating an example of a list of capability information obtained from a printing apparatus in the first embodiment as a table.

FIG. 9 is a view illustrating an example of a list of print functions supported by the expansion application as a table.

FIG. 10 is a view illustrating an example of a list of print functions supported by general-purpose print software as a table.

FIG. 11 is a sequence diagram illustrating operations of a drawing application, the general-purpose print software, the expansion application, and the printing apparatus in the first embodiment.

FIG. 12 is a block diagram illustrating a software configuration of a print system in which an expansion application in a second embodiment is associated with the general-purpose print software and the printing apparatus.

FIG. 13 is a flowchart illustrating a PDC editing process performed by a print function expansion unit of the expansion application in the second embodiment.

FIG. 14 is a view illustrating an example of a list of capability information obtained from a printing apparatus in the second embodiment as a table.

FIG. 15 is a sequence diagram illustrating operations of the drawing application, the general-purpose print software, the expansion application, and the printing apparatus in the second embodiment.

FIG. 16 is a view illustrating an example of a list of capability information obtained from a printing apparatus in a third embodiment as a table.

FIG. 17 is a sequence diagram illustrating operations of the drawing application, the general-purpose print software, the expansion application, and the printing apparatus in the third embodiment.

FIG. 18 is a sequence diagram illustrating operations of the drawing application, the general-purpose print software, the expansion application, and the printing apparatus in a fourth embodiment.

FIGS. 19A, 19B, and 19C are views illustrating examples of advanced setting screens and a print setting screen when the print setting expansion unit of the expansion application in the fourth embodiment displays a preview image.

FIG. 20 is a sequence diagram illustrating operations of the drawing application, the general-purpose print software, the expansion application, and the printing apparatus in a fifth embodiment.

FIG. 21 is a view illustrating an example of the print setting screen when the print-setting-screen expansion unit of the expansion application in the fifth embodiment displays a warning image.

### DESCRIPTION OF THE EMBODIMENTS

Hereinafter, embodiments of the present disclosure will be described in detail with reference to the drawings. However, configurations described in the following embodiments are merely examples, and the scope of the present disclosure is not limited by the configurations described in the embodiments. For example, not all combinations of features described in the embodiments are necessarily essential to the solution of the present disclosure. For example, each unit constituting the present disclosure can be replaced with any configuration capable of exhibiting the same function. Further, an arbitrary component may be added. Any two or more configurations (features) of the embodiments can be combined. In second and subsequent embodiments, the same reference numerals are given to the same configurations and processes as those in a first embodiment and duplicated descriptions thereof will be omitted.

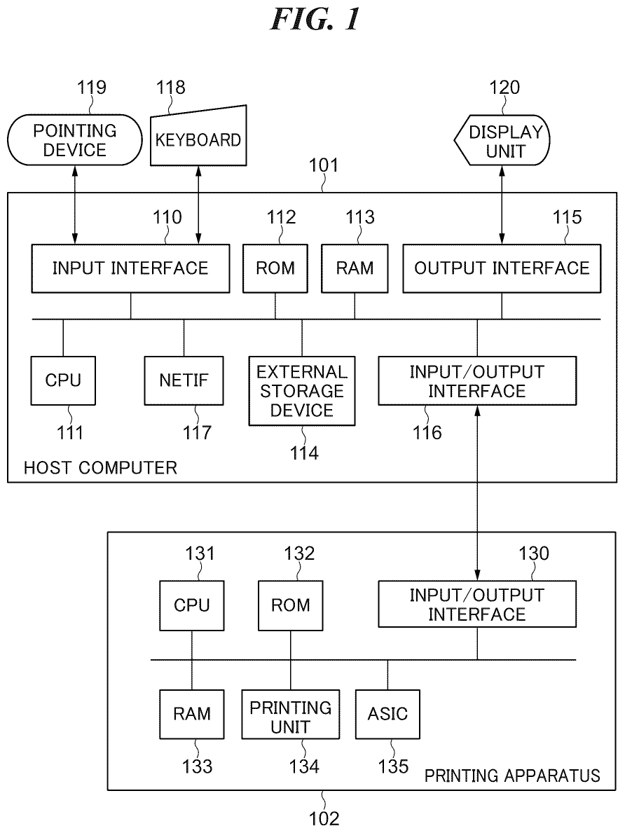

Hereinafter, the first embodiment will be described with reference to FIGS. 1 to 11. FIG. 1 is a block diagram illustrating a hardware configuration of a printing system. As illustrated in FIG. 1, the print system has a host computer 101 and a printing apparatus 102. The host computer 101 (an information processing apparatus) may be a desktop personal computer, a smartphone, a notebook personal computer, or a tablet terminal. In FIG. 1, the host computer 101 includes an input interface 110, a CPU 111, a ROM 112, a RAM 113, an external storage device 114, an output interface 115, an input/output interface 116, and a NETIF 117. Further, input devices, such as a keyboard 118 and a pointing device 119, are connected to the input interface 110, and a display device such as a display unit 120 is connected to the output interface 115.

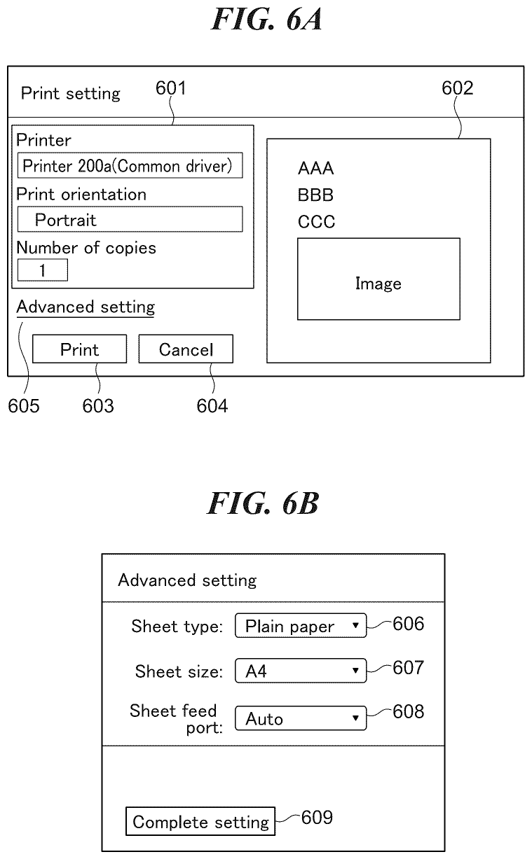

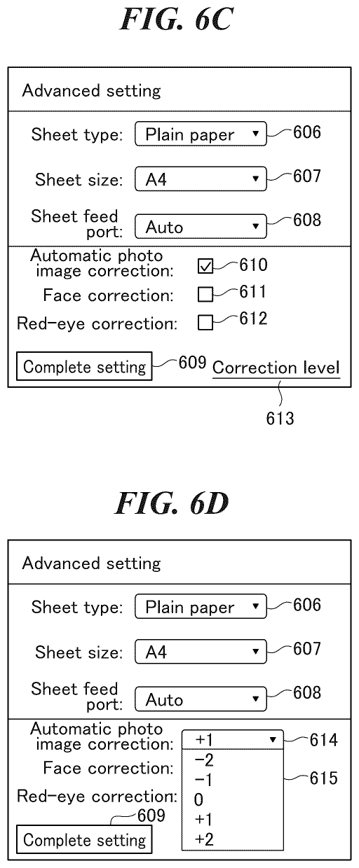

For example, a print setting screen, an advanced setting screen, and the like illustrated in FIGS. 6A to 6D described later are displayed on the display unit 120. The NETIF 117 is a network interface that controls data transmission with an external apparatus via a network. The ROM 112 stores an initialization program. The external storage device 114 stores an application program group, an operating system (OS), print data generation software, and other various kinds of data. The RAM 113 is used as a work memory when executing various programs stored in the external storage device 114. In this manner, the various programs are operable in the host computer 101. In the first embodiment, functions described later in the host computer 101 are achieved by the CPU 111 executing processes according to procedures of the programs stored in the external storage device 114, and the processes shown by flowcharts and sequence diagrams are performed.

The printing apparatus 102 is connected to the input/output interface 116 of the host computer 101. The printing apparatus 102 includes an input/output interface 130, a CPU 131, a ROM 132, a RAM 133, a printing unit 134, and an ASIC 135. The input/output interface 116 of the host computer 101 is connected to the input/output interface 130. The CPU 131 controls the entire printing apparatus 102. The ROM 132 stores a control program of the printing apparatus 102 and the like. The RAM 133 provides a memory area for temporarily storing various information when the CPU 131 executes the program.

The printing unit 134 forms an image on a sheet by an electrophotographic method. However, the printing apparatus 102 is not limited to this, and may be an apparatus using another process such as an inkjet method. The ASIC 135 has a photo correction module to perform an image process related to a photo correction function described later, and further performs a print process. The printing apparatus 102 may be a multifunction peripheral having a plurality of functions, such as copy, print, and facsimile. In addition, although the host computer 101 and the printing apparatus 102 are separately configured here, these may be configured as one apparatus.

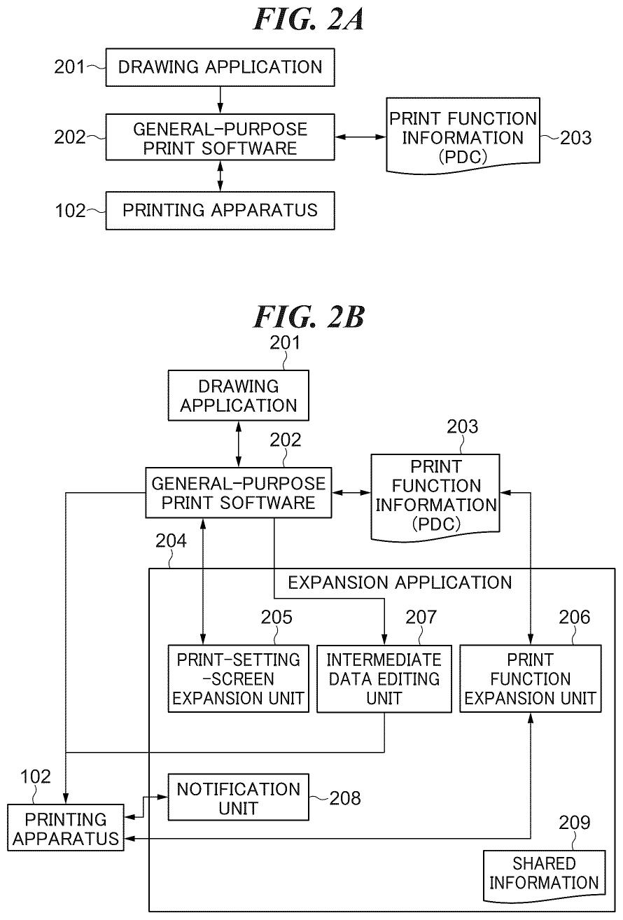

FIGS. 2A and 2B are block diagrams showing software configurations of the print system. The following description is based on the print system using the host computer 101 on which Windows (registered trademark) 11 of Microsoft (registered trademark) is installed as the OS. FIG. 2A shows a drawing application 201, a general-purpose printing software 202, and a print capability information 203 as a general software configuration of the print system. FIG. 2B shows an expansion application 204 in addition to the general software configuration of the print system shown in FIG. 2A.

That is, FIG. 2A is the diagram showing the general configuration in the case where the expansion application 204 is not associated with the general-purpose print software 202 and the printing apparatus 102. FIG. 2B shows the configuration in which the expansion application 204 is associated with the general-purpose printing software 202 and the printing apparatus 102. The drawing application 201, the general-purpose printing software 202, the print function information 203, and the expansion application 204 are stored in the external storage device 114 of the host computer 101.

First, the software configuration of the print system in which the expansion application 204 is not associated with the general-purpose printing software 202 and the printing apparatus 102 will be described with reference to FIG. 2A. The drawing application 201 is software for generating contents (drawing data) to be printed. The drawing application 201 corresponds to, for example, a document creation application, a spreadsheet application, or the like. Upon receiving a print request from a user, the drawing application 201 issues a print instruction to the OS. The print instruction includes print setting information for instructing operations of the general-purpose print software 202 and the printing apparatus 102. The print setting information is also referred to as a Print Ticket (hereinafter, referred to as “PT”).

The drawing application 201 can display a print setting screen provided by any of the general-purpose printing software 202, the OS, and the drawing application 201 in order to output a PT. When an advanced setting button in the print setting screen is selected, the general-purpose print software 202 additionally displays an advanced setting screen. Details of the print setting screen and the advanced setting screen will be described later with reference to FIGS. 6A, 6B, 6C, and 6D. The advanced setting screen includes a setting item indicating a print function that can be set by a user and a control item indicating a set value of the setting item, in accordance with capability information of the general-purpose print software 202. The capability information is also called Print Capabilities (hereinafter, referred to as “PC”).

The general-purpose print software 202 is a software program capable of generating print data that can be printed by a plurality of printing apparatuses provided by different manufacturers. The general-purpose print software 202 determines the PC based on the print function information 203. The print function information 203 is data indicating all print functions that can be set by a user, the set values thereof, and print functions in which the exclusive relationship between the set values is described. The print function information 203 is also called PDC (Print Device Capabilities). Hereinafter, the print capability information 203 is referred to as “PDC 203”. The PDC 203 are included in a configuration file of the general-purpose print software 202 that is stored in the external storage device 114 of the host computer 101 as an unchangeable file.

Alternatively, the PDC 203 may be dynamically generated by the general-purpose print software 202 or the OS. Specifically, the general-purpose print software 202 or the OS can be configured to obtain attribute data of the printing apparatus 102 from the printing apparatus 102 and generate the PDC 203 in accordance with the attribute information in the obtained attribute data. When the PDC 203 are dynamically generated, the generated PDC 203 can be edited. The attribute data of the printing apparatus 102 is a response obtained by issuing a Get-Printer-Attributes operation of IPP (Internet Print Protocol) to the printing apparatus 102. The response includes attribute information indicating a function that can be set to the printing apparatus 102 and a set value related to the attribute information. This response is stored in the RAM 113.

With this configuration, the general-purpose print software 202 allows the user to set the print function available in the printing apparatus connected to the host computer 101. That is, even when a printing apparatus having a different function or a printing apparatus developed by a different manufacturer is connected, the general-purpose print software 202 allows the user to set a print function available in the connected printing apparatus.

Hereinafter, a configuration using an IPP Class Driver installed in Windows (registered trademark) 11 as the general-purpose print software 202 will be described. The IPP class driver is a printer driver that executes a print process in accordance with the specification of a standard print protocol called IPP, and is included in the package of the OS. The IPP Class Driver is not a unique printer driver corresponding to the model of the printing apparatus 102, but is a standard class driver that can be commonly used among a plurality of types of printing apparatuses. That is, the general-purpose print software 202 is a standard driver provided by Microsoft Corporation, which is a provider of Windows (registered trademark) 11 as the OS.

The IPP Class Driver obtains the capability information of the connected printing apparatus 102 and generates the PDC 203 on the basis of the obtained capability information of the printing apparatus 102 so that the user can set the print function supported by the connected printing apparatus 102. However, the IPP Class Driver does not support the photo correction functions. This is because the photo correction functions are functions unique to a manufacturer. Therefore, the photo correction functions will be described below.

As described above, the photo correction functions include the automatic photo image correction function, the face correction function, and the red-eye correction function. The automatic photo image correction function is to analyze brightness, saturation, and hue of print data and correct brightness, saturation, hue, contrast, and color cast on the basis of distributions of values obtained by the respective analyses. The face correction function is to detect a face area of the print data and correct brightness on the basis of a brightness distribution in the detected face area and a brightness distribution of the entire print data. The red-eye correction function is to detect a red-eye region in the print data and correct the red-eye region based on the brightness and saturation information of the detected red-eye region to make an eye have a natural color tone. The automatic photo image correction function, the face correction function, and the red-eye correction function can be applied individually or in combination as described above.

In addition, the photo correction functions may include a backlight correction function, a night scene correction function, and the like. The backlight correction function is to correct a dark portion due to backlight in a photo image captured in a backlight environment. The night scene correction function is to suppress noise in a photo image captured in a dark environment such as a night scene.

As examples of functions included in the photo correction functions, the automatic photo image correction function, the face correction function, and the red-eye correction function will be described. In the following description, input print data shall be general RGB data constituted by three channels of R, G, and B each of which is an 8-bit value (0 to 255). However, this is not limited. First, the automatic photo image correction function will be described.

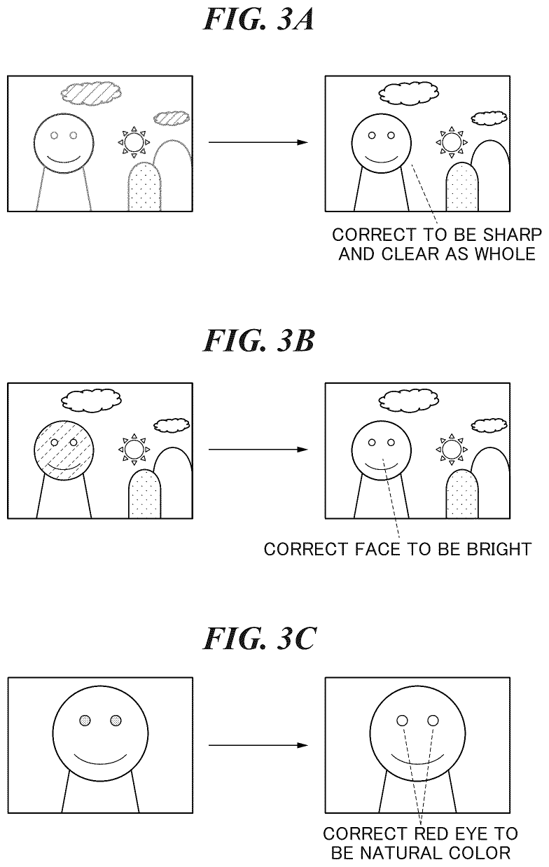

The automatic photo image correction function is to automatically perform corrections, such as improvement of contrast of an image by a dynamic range correction or a contrast correction and improvement of vividness by a saturation correction, on a photo image in which a person, a landscape, or the like is captured, as illustrated in FIG. 3A, for example. The automatic photo image correction function calculates correction values related to the dynamic range, contrast, and saturation on the basis of feature amounts related to the color obtained by analyzing the print data. More specifically, a histogram of Y values representing brightness among YC1C2 values converted from RGB values of the print data is generated, and the feature amount is calculated from the shape of the generated histogram. Then, the correction values are calculated on the basis of the calculated feature amount and the information about the saturation and the hue associated with the feature amount. Note that a color is represented by brightness Y and chromaticities C1 and C2 in a YC1C2 color space. The YC1C2 color space is one of color spaces in which brightness, saturation, and hue are easily handled.

Hereinafter, a specific analysis method of the print data will be described. First, RGB values of all pixels of the print data (hereinafter, abbreviated as “all pixels”) are converted into YC1C2 values by the following equation 1.

$$\begin{matrix}Y = 0.3 R + 0.59 G + 0.11 B \\ C 1 = R - Y \\ C 2 = B - Y\end{matrix} \qquad ( 1 )$$

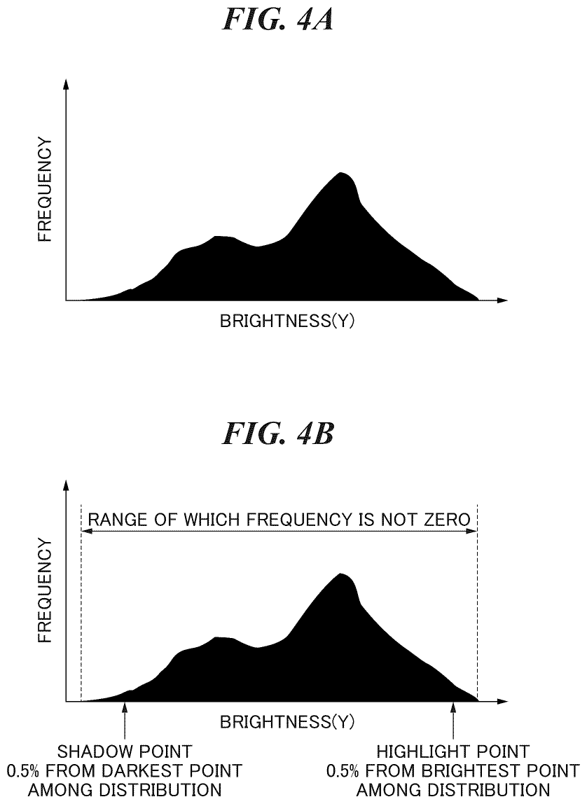

As can be understood from the equation 1, if each of RGB values falls within a range of 0 to 255, each of YC1C2 values also falls within a range of 0 to 255. The histogram of the Y values is then generated. The histogram is generated by counting the number of pixels having the Y value of each of 0 to 255 among all the pixels. FIG. 4A is a view illustrating an example of the generated histogram. In the histogram in FIG. 4A, a horizontal axis (brightness) indicates the Y values from 0 to 255. A vertical axis (frequency) indicates the number of pixels among all the pixels for each of the Y values of 0 to 255.

After the histogram is generated, a shadow point and a highlight point are calculated as the feature amounts. The shadow point may be the darkest Y value in a range of the histogram distribution where the frequency is not 0, that is, the smallest Y value in the range of the histogram distribution. The highlight point may be the brightest Y value in the range of the histogram distribution, that is, the largest Y value in the range of the histogram distribution. However, in the first embodiment, the shadow point is described as a Y value that is 0.5% brighter than the darkest Y value, and the highlight point is described as a Y value that is 0.5% darker than the brightest Y value in order to prevent noise in the histogram distribution. This is merely an example and the shift rate may not be 0.5%, and the darkest Y value and the brightest Y value may be employed as the shadow point and the high light point, respectively. FIG. 4B is a graph illustrating the shadow point and the high light point on the histogram.

In addition, the central Y value in the range of the histogram distribution is calculated together with the shadow point and the high light point. The median Y value Y_{med} in the range of the histogram distribution is calculated by the following equation 2.

$${Y}_{m e d} = \frac{{Y}_{s d} + {Y}_{h 1}}{2} \qquad ( 2 )$$

In the equation 2, Y_{med} is the central Y value in the range of the histogram distribution, Y_{sd} is a Y value of the shadow point, and Yₕₗ is a Y value of the high light point. The above is the description of the specific method of analyzing the printed data.

Subsequently, the dynamic range correction, the contrast correction, and the saturation correction are performed in this order on the basis of the feature amounts obtained by the analysis of the print data. First, the dynamic range correction is performed by the following equation 3.

$$In a case of {Y}_{i n} < {Y}_{m e d} : \qquad ( 3 )$$

$${Y}_{sd\_c} = {Y}_{s d} - {Y}_{dk}$$

$${Y}_{out} = {Y}_{i n} - {Y}_{sd\_c} ( 1 - \frac{{Y}_{i n}}{{Y}_{m e d}} )$$

$$In a case of {Y}_{i n} \geq {Y}_{m e d} :$$

$${Y}_{h1\_c} = {Y}_{h 1} - {Y}_{w h}$$

$${Y}_{out} = {Y}_{i n} - {Y}_{h {1}_{c}} ( \frac{{Y}_{i n}}{{Y}_{m e d}} - 1 )$$

In the equation 3, Yᵢₙ is a Y value of each pixel of the print data, Y_{dk} is the darkest Y value (usually 0), Y_{wh} is the brightest Y value (usually 255), and Yₒᵤₜ is a Y value after the dynamic range correction. The calculation according to the equation 3 is performed for all pixels.

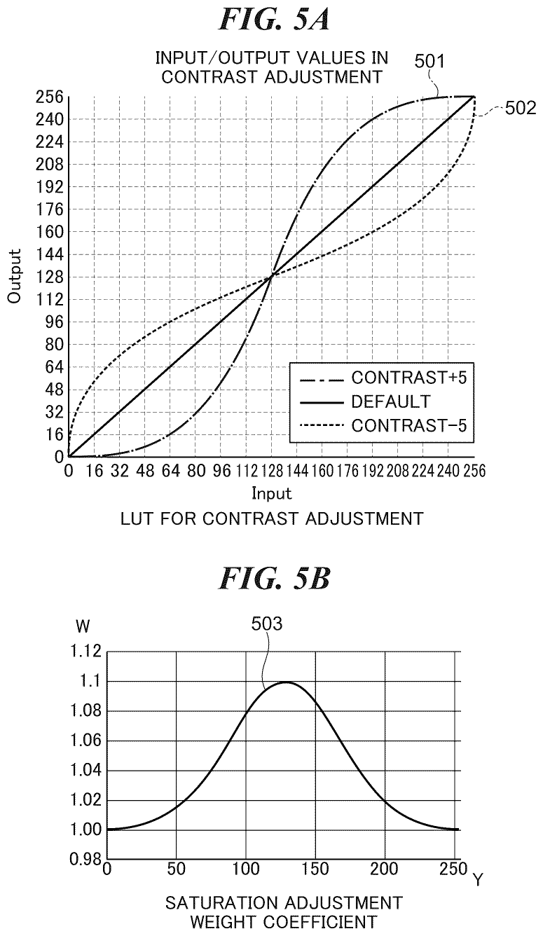

Next, the contrast correction is performed. The contrast correction is performed by tone curve correction for the Y values. FIG. 5A is a graph illustrating tone curves in the contrast correction. The tone curve 501 for emphasizing the contrast is set such that an output signal value is smaller than an input signal value in a low signal range of 0 to 127, and an output signal value is larger than an input signal value in a high signal range of 128 to 255. Accordingly, the correction using the tone curve 501 enlarges the difference between the signal values in the low signal range and the signal values in the high signal region, and thus the difference in color visually increases, and a clear impression is obtained. The contrast correction is performed by converting the Y values after the dynamic range correction for all the pixels with such a tone curve 501. The correction with the tone curve 502, which is not used by the automatic photo image correction function in the first embodiment, reduces the difference between the signal values in the low signal range and the signal values in the high signal range, which weakens the contrast and so that a visually natural and soft impression can be obtained.

Finally, the saturation correction is performed. The saturation can be increased by increasing the C1 value and the C2 value. However, when the balance between the C1 value and the C2 value is lost, the hue, that is, the color tone is changed. The saturation correction increases the saturation without changing the hue by increasing the C1 value and the C2 value while holding the balance between the C1 value and the C2 value. As a general color characteristic, the range of possible saturation depends on the brightness, that is, the Y value. Specifically, the brighter or darker the image is, the narrower the range of possible saturation is, but at intermediate brightness, the range of possible saturation is maximized at an intermediate brightness. Therefore, in the saturation correction, the amount of increase in saturation is increased as the brightness approaches the intermediate brightness. The saturation correction is performed by the following equation 4.

$$C {1}_{c} = C 1 \cdot W \qquad ( 4 )$$

$$C {2}_{c} = C 2 \cdot W$$

In the equation 4, C1_{C} and C2_{C} are the C1 and C2 values after the saturation correction, and W is a correction ratio for the C1 and C2 values according to the Y value, and is defined by a one dimensional conversion (look up) table (1DLUT) as illustrated by a curve 503 in FIG. 5B. In the graph of the 1DLUT in FIG. 5B, the horizontal axis indicates the Y value, the vertical axis indicates the correction ratio W, and when the Y value is 128, which is the intermediate brightness, the W reaches the maximum value 1.11. The graph of the 1DLUT in FIG. 5B is an example, and this is not limited. It is enough that a 1DLUT increases the increase amount of the saturation as the brightness approaches the intermediate brightness.

The automatic photo image correction function has been described above. Although the method of each correction in the automatic photo image correction function described above is simple, a correction amount may be controlled according to the feature amounts. For example, each correction amount may be suppressed or increased according to the shape of the histogram. In the automatic photo image correction function, since each correction is performed in the YC1C2 space, YC1C2 values after the correction is converted into RGB values by an inverse operation equation of the equation 1. However, when the printing apparatus 102 can accept an input of the YC1C2 space, the corrected YC1C2 values may be transmitted to the printing apparatus 102 as the print data without being converted.

Next, the face correction function will be described. The face correction function is to detect a face area of print data (hereinafter, abbreviated as a “face area”) and calculate a correction amount according to a color analysis result of the detected face area, thereby correcting the face area. As shown in FIG. 3B, the face correction function brightens a face that has become dark due to backlight in an image in which a person's face is captured. In the face correction function, first, RGB values of all pixels are converted into YC1C2 values by the above equation 1, similarly to the automatic photo image correction function. Subsequently, the image formed by the Y values is spatially analyzed, thereby the face area is extracted. In recent years, face extraction techniques have been developed, and many techniques to automatically extract a face area from an image in which a person is captured have been proposed. For example, a technique to extract a face by performing a filter analysis and a technique to extract a skin color area from a color difference signal have been proposed. Further, various techniques have been proposed, such as a technique to extract a face area along a contour of a face and a technique to detect a center point of a face and define a predetermined area as a face. A face area may be extracted by any known technique.

Next, a histogram of the Y values of the extracted face area is generated. The method of generating the histogram is the same as that of the automatic photo image correction function. After the histogram of the Y values in the face area is generated, an average Yₐᵥᵣ of the Y values in the face area is obtained. In the face correction function, the average luminance value in the face area is used to determine the corrected Y value, but this is not limited. For example, the center value of the histogram in the face area may be used, the maximum value of the histogram in the face area may be used in the process of brightening a dark image, or the peak value of the histogram may be used if the histogram of the face area shows a mountain shape distribution. Subsequently, an average Y_{all_avr} of the Y values of all the pixels is obtained.

Then, a corrected value Y_{cor} is calculated from the calculated average Yₐᵥᵣ in the face area and the average Y_{all_avr} of all the pixels. The corrected value Y_{cor} is calculated by the following equation 5.

In the case of Yₐᵥᵣ<Y_{all_avr}

$${Y}_{c o r} = {Y}_{i n} + ( {Y}_{all\_avr} - {Y}_{a v r} ) \cdot {W}_{c} \qquad ( 5 )$$

In the equation 5, Yᵢₙ is the Y value of the pixel in the face area, and W_{c} is a weight coefficient. Normally, the value of W_{c} may be 1, but a correction amount can be controlled by changing the value of W_{c}. For example, the value of W_{c} may be changed according to the shape of the face region or the histogram of all the pixels. As shown in the equation 5, the corrected value Y_{cor} is calculated only when the average Yₐᵥᵣ in the face area is darker than the average Y_{all_avr} of all the pixels. This is because, when the face is dark due to backlight, that is, when the average Yₐᵥᵣ in the face area is darker than the average Y_{all_avr} of all the pixels, many users feel that the face is dark. However, the face correction function can be achieved in a case other than the above-described case. The face correction function may darken the face area depending on a condition of an image. For example, the face correction function can darken the face area in accordance with brightness of the entire image when only the face area appears to be bright and floating.

Finally, the red-eye correction function will be described. For example, as illustrated in FIG. 3C, the red-eye is a phenomenon in which the eyes are reddened by the reflection of flash light in photographing, and the red-eye correction function corrects the reddened eye portions to a natural color. In the red-eye correction function, first, a red-eye area is extracted. The red-eye correction function detects a cluster of red pixels, determine whether the detected cluster is an eye, and extracts the cluster determined to be an eye as a red-eye area. More specifically, all the pixels are binarized into red and the others, and it is determined whether a cluster of pixels detected as red (hereinafter referred to as a “red pixel cluster”) is circular. Further, it is determined whether there are two red pixel clusters having the same size and shape at a predetermined interval among the red pixel clusters determined to be circular. At this time, if it is determined that there are two red pixel clusters having the same size and shape at the predetermined interval, the two determined red pixel clusters are extracted as the red-eye areas. Further, center positions of the respective extracted red-eye areas are calculated.

Subsequently, the extracted red-eye areas are corrected. First, RGB values of the pixels in the red-eye areas are converted into YC1C2 values by the above equation 1 as with the automatic photo image correction function. Further, the saturation is calculated from the YC1C2 values. The saturation is calculated by the following equation 6.

$$S = \sqrt{C {1}^{2} + C {2}^{2}} \qquad ( 6 )$$

Next, the pixels in the red-eye areas are corrected by the converted YC1C2 values of the pixels in the red-eye areas and the following equation 7.

$${V}_{Y} = \{ 1 - {( \frac{r}{{r}_{0}} )}^{{T}_{Y 1}} \} \cdot \{ 1 - {( 1 - \frac{{S}_{R}}{{S}_{R\_max}} )}^{{T}_{Y 2}} \} \cdot \{ 1 - {( \frac{Y}{{Y}_{max}} )}^{{T}_{Y 3}} \} {V}_{c} = \{ 1 - {( \frac{r}{{r}_{0}} )}^{{T}_{C 1}} \} \cdot \{ 1 - {( 1 - \frac{{S}_{R}}{{S}_{R\_max}} )}^{{T}_{C 2}} \} {Y}_{n e w} = ( 1.0 - {W}_{Y} \cdot {V}_{Y} ) \cdot {Y}_{o l d} {C}_{n e w} = ( 1.0 - {W}_{C} \cdot {V}_{C} ) \cdot {C}_{o l d} \qquad ( 7 )$$

In the equation 7, r is a distance from the center of the red-eye area to a target pixel, and r₀ is the distance from the center of the red-eye area to a circle boundary. In addition, S_{R} is the saturation of the target pixel, and S_{R_max} is the maximum saturation in the red-eye area, Y is brightness of the target pixel, Yₘₐₓ is the maximum brightness in the red-eye area. Further, Y_{old} and C_{old} are the Y, C1, and C2 values before the correction, Y_{new} and C_{new} are the Y, C1, and C2 values after the correction. Still further, T_{Y1}, T_{Y2}, T_{Y3}, T_{C1}, T_{C2}, W_{Y}, and W_{C} are arbitrary parameters to adjust the correction amount.

Referring back to the description of FIG. 2A. When a print instruction is issued from the drawing application 201, a module of the OS in the general-purpose print software 202 generates intermediate data. The data output for printing by the drawing application 201 is data in the Graphic Device Interface format (GDI format data) or data in the XML Paper Specification format (XPS format data). Here, a case where an IPP Class Driver is used as the general-purpose print software 202 is assumed. In this case, when the data output from the drawing application 201 is data in the GDI format, the OS converts the data in the GDI format output from the drawing application 201 into data in the XPS format. The intermediate data includes drawing data that is information about an image formed on a paper sheet and a PT set by the user.

The general-purpose print software 202 converts the generated intermediate data into print data that can be interpreted by the printing apparatus 102, and transmits the converted print data to the printing apparatus 102. Here, the print data is Page Description Language (PDL) data conforming to the IPP. The PDL data conforming to the IPP is, for example, data in a PDF (Portable Document Format) or a PWG-Raster format. The print data includes the drawing data that is information about an image formed on a paper sheet and print setting attribute information (attribute information to set a print setting) generated based on the PT set by the user. The print setting attribute information includes attribute information indicating a function that can be set in the printing apparatus 102 and a set value related to the attribute information.

The printing apparatus 102 performs printing on a paper sheet based on the print data sent from the general-purpose print software 202. At this time, the printing apparatus 102 forms the drawing data included in the print data on a paper sheet by an operation according to the print setting attribute information included in the print data. The print setting attribute information includes the attribute information for designating print quality (image quality priority, speed priority, etc.), double-sided printing, etc., and set values thereof. For example, when the print setting attribute information includes attribute information designating the double-sided printing and a set value indicating that the double-sided printing is to be operated, the printing apparatus 102 executes the double-sided printing.

Next, the software configuration of the print system in which the expansion application 204 is associated with the general-purpose print software 202 and the printing apparatus 102 will be described with reference to FIG. 2B. Note that the configuration and process not particularly mentioned below are the same as those in FIG. 2A. The expansion application 204 (an application program) is software to expand the function of the general-purpose print software 202, and is software that is not included in the OS in advance (not packaged together with the OS).

As such, the user needs to operate the host computer 101 and download the expansion application 204 from a server to the host computer 101 via the Internet and install it. Alternatively, the expansion application 204 may be automatically installed in the host computer 101 in response to the connection of the printing apparatus 102 to the host computer 101. Specifically, when the printing apparatus 102 is connected to the host computer 101, the OS obtains device identification information from the printing apparatus 102. Further, the OS downloads the expansion application 204 corresponding to the obtained device identification information from the server to the host computer 101 via the Internet and installs the expansion application. That is, the general-purpose print software 202 and the expansion application 204 are stored in the host computer 101 as different files. The expansion application 204 may be installed in the host computer 101 by reading the expansion application 204 stored in a storage medium by the CPU 111 of the host computer 101.

The general-purpose print software 202 and the expansion application 204 may be updated and upgraded, but these update processes are also performed at different timings. That is, the timing at which the host computer 101 obtains the general-purpose print software 202 is different from the timing at which the host computer 101 obtains the expansion application 204. Further, a trigger for the host computer 101 to obtain the general-purpose print software 202 is different from a trigger for the host computer 101 to obtain the expansion application 204. When the expansion application 204 is installed, the OS associates the expansion application 204 with the general-purpose print software 202 and the printing apparatus 102.

As shown in FIG. 2B, the expansion application 204 has a print-setting-screen expansion unit 205, a print function expansion unit 206, an intermediate data editing module 207, and a notification unit 208. The expansion application 204 has shared information 209 that can be accessed in common by the units. The actual state of the shared information 209 is a file stored in the external storage device 114 or the information stored in the RAM 113 in the host computer 101. The expansion application 204 writes and reads information to and from the shared information 209 by using an API (Application Program Interface) provided by the OS. Note that the expansion application 204 may end the operation every time a process of each unit is finished. In this case, the OS activates the expansion application 204 every time a request to use each unit is received. Further, the expansion application 204 may cancel a process in the process of each unit. When the process is cancelled, the OS deletes the job in processing on the print queue.

Upon receiving a print request from the user, the drawing application 201 issues a print instruction to the OS. Even in the configuration of FIG. 2B, the drawing application 201 can display the print setting screen as with the configuration of FIG. 2A. Further, in the configuration of FIG. 2B, the advanced setting screen provided by the expansion application 204 is displayed. Specifically, the advanced setting screen provided by the print-setting-screen expansion unit 205 of the expansion application 204 is displayed. The print-setting-screen expansion unit 205 can store information about the advanced setting set by the user in the shared information 209. The print-setting-screen expansion unit 205 will be described in detail later.

The intermediate data editing unit 207 obtains the intermediate data from the general-purpose print software 202, converts the obtained intermediate data into the print data, and then passes the converted print data to the printing apparatus 102. At this time, the intermediate data editing unit 207 obtains the information about the advanced setting from the shared information 209 and adds the obtained advanced setting of the information to the print data. The printing apparatus 102 applies a necessary image process to the received print data and prints on a paper sheet. The method of converting the intermediate data into the print data is not limited to the above method. For example, the expansion application 204 may obtain the print data obtained by converting the intermediate data by the general-purpose print software 202 and add the advanced setting to the obtained print data. In addition, in the configuration of FIG. 2B, there is a case where a photo correction setting is not performed by the user. In this case, the general-purpose print software 202 may pass the print data to the printing apparatus 102 without passing through the expansion application 204 as with the configuration of FIG. 2A.

The print function expansion unit 206 can edit the PDC 203 generated by the general-purpose print software 202 or the OS. Accordingly, the print function expansion unit 206 can add a function provided by the expansion application 204 or a function (for example, a photo correction function) that is supported by the printing apparatus 102 but is not supported by the general-purpose print software 202. Further, the print function expansion unit 206 can add an exclusive relationship between set values of the print function. The OS activates the print function expansion unit 206 when the expansion application 204 is associated with the printing apparatus 102 and the general-purpose print software 202 at first. Further, the OS may activate the print function expansion unit 206 at other timings (for example, activation of the OS). In this way, in a case where an optional apparatus (for example, a finisher) is added to the printing apparatus 102 later and functions relating to printing are expanded, the print function expansion unit 206 can detect the expanded function and add it to the PDC 203.

The notification unit 208 can display a notification to the user in response to an error occurring in the printing apparatus 102. For example, when a paper empty error occurs in the printing apparatus 102, the general-purpose print software 202 detects the error, and the OS causes the display unit 120 to display a message using a notification function called a toast notification, which is a function of the OS. When the user selects the toast notification with the pointing device 119, the notification unit 208 is called by the OS, and a notification screen of the notification unit 208 is displayed. The notification unit 208 can display, for example, a detailed message of the paper empty error and a paper filling method on the notification screen.

When the expansion application 204 transmits the print data to the printing apparatus 102 once, the expansion application 201 cannot display a screen such as a guide associated with the print data during the process of each unit. The configuration of the expansion application 204 is not limited to the configuration having all the functions (units) described above, and may be a configuration having only a part of the functions or a configuration having other functions. The expansion application 204 may be simply referred to as printing software.

As described above, the expansion application 204 has at least one of the following functions. The first function is the function of displaying the setting screen (the print-setting-screen expansion unit 205). The second function is the function of editing the intermediate data to convert the intermediate data into the print data and adding the advanced setting to the print data (the intermediate data editing unit 207). The third function is the function of expanding a function that can be set by the print data generation software (the print function expansion unit 206). The fourth function is the function of displaying a screen in response to the occurrence of an error in the printing apparatus 102 (the notification unit 208).

Next, examples of the print setting screen and the advanced setting screen will be described with reference to FIGS. 6A to 6D. FIG. 6A is a view illustrating the print setting screen displayed by the drawing application 201. FIG. 6B is a view illustrating the advanced setting screen displayed in the case of the configuration shown in FIG. 2A, that is, the configuration without the expansion application 204. FIGS. 6C and 6D are views illustrating the advanced setting screens displayed in the case of the configuration shown in FIG. 2B, that is, the configuration having the expansion application 204. The unit or module for displaying the print setting screen is not limited to the above. For example, the print-setting-screen expansion unit 205 may be configured to only generate the print setting screen. In this case, the print-setting-screen expansion unit 205 transmits the generated print setting screen to the drawing application 201 via the general-purpose print software 202. The drawing application 201 displays the print setting screen obtained in this manner.

First, the print setting screen shown in FIG. 6A will be described. In a control 601, a printer (that is, a printing apparatus) used for printing, a print orientation, and the number of copies can be set by a user. A control 602 is a preview image before the photo correction, a control 603 is a button to start printing, and a control 604 is a button to cancel printing. A control 605 is an advanced setting button. When the control 605 is selected with the pointing device 119, the general-purpose print software 202 or the print-setting-screen expansion unit 205 additionally displays the advanced setting screen.

Next, the advanced setting screen shown in FIG. 6B will be described. FIG. 6B illustrates the advanced setting screen that is additionally displayed by the general-purpose print software 202 in the absence of the expansion application 204. In a control 606, a sheet type can be set by a user, and in FIG. 6B indicates that “Plain paper” is set. In a control 607, a sheet size can be set by the user, and FIG. 6B indicates that an “A4” size is set. In a control 608, a sheet feeding port can be set by the user, and FIG. 6B indicates that “Auto” is set. A control 609 is a setting completion button. When the control 609 is selected with the pointing device 119, the advanced setting screen shown in FIG. 6B returns to the print setting screen shown in FIG. 6A.

Next, the advanced setting screens shown in FIGS. 6C and 6D will be described. FIGS. 6C and 6D illustrate the advanced setting screens additionally displayed by the print-setting-screen expansion unit 205 when the expansion application 204 is present. In the advanced setting screen shown in FIG. 6C, controls 610 to 613 are added to the advanced setting screen in FIG. 6B. The control 610 is a button that enables the user to select the automatic photo image correction function from among the photo correction functions. The control 611 is a button that enables the user to select the face correction function from among the photo correction functions. The control 612 is a button that enables the user to select the red-eye correction function from among the photo correction functions. FIG. 6C indicates that the automatic photo image correction function is selected from among the photo correction functions. A plurality of photo correction functions may be selected. A control 613 is a correction level button. When the control 613 is selected with the pointing device 119, the print-setting-screen expansion unit 205 changes the advanced setting screen in FIG. 6C to the advanced setting screen in FIG. 6D.

On the advanced setting screen shown in FIG. 6D, controls 614 and 615 are added to the advanced setting screen in FIG. 6B. The controls 614 and 615 are drop-down lists that allow the user to set the correction level of the automatic photo image correction function to user, and indicate that “+1” is set in FIG. 6D. In the controls 614 and 615, the user can set the correction level of the automatic photo image correction function in five steps, and can weaken (−direction) or strengthen (+direction) the correction level with “0” as the center. On the advanced setting screen in FIG. 6D, when the face correction or the red-eye correction is selected on the advanced setting screen in FIG. 6C, the user can set the correction level of the selected function in three steps in the similar drop-down list. A control that allows a user to set the correction level is not limited to the list format such as the controls 614 and 615, and may be any format (for example, a slide format).

Here, the reason why the print setting items are different in the advanced setting screens in FIGS. 6B, 6C, and 6D will be described. The advanced setting screen is generated with reference to the PC generated based on the PDC 203. However, since the general-purpose print software 202 does not support the photo correction functions (more specifically, the automatic photo image correction function, face correction function, and red-eye correction function), the photo correction functions cannot be added to the PDC 203. Even if the photo correction functions are originally included in the PDC 203, the general-purpose print software 202 cannot interpret the photo correction functions included in the PDC 203. Therefore, the general-purpose print software 202 cannot display the controls 610 to 615 for the photo correction setting on the advanced setting screen. On the other hand, when the expansion application 204 is provided, the print function expansion unit 206 adds the photo correction function to the PDC 203, and the print-setting-screen expansion unit 205 displays the advanced setting screen with reference to the PC. With these configurations, the expansion application 204 can display the controls 610 to 615 capable of setting the photo correction functions on the advanced setting screen.

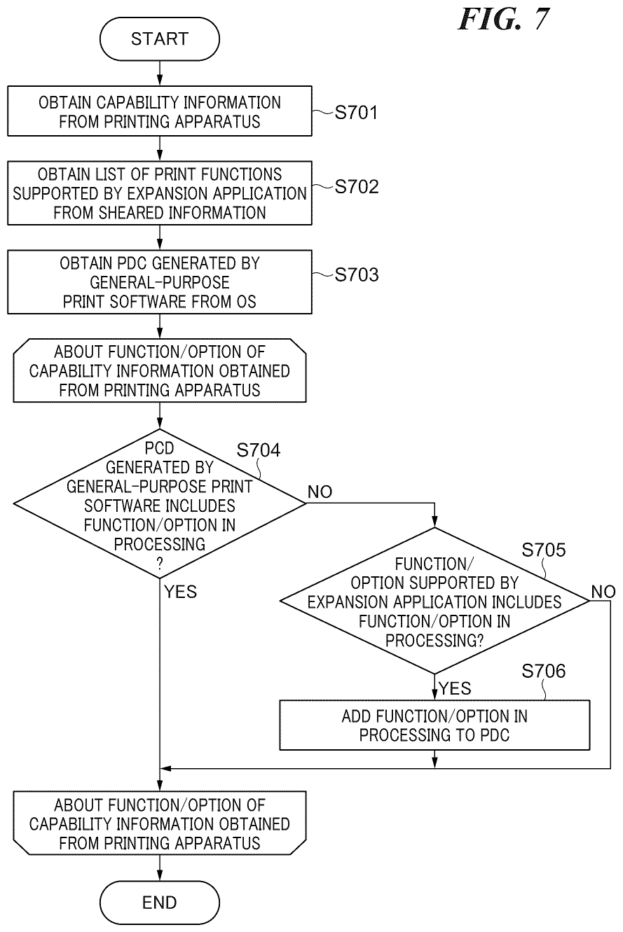

Here, a flow of an editing process of the PDC 203 executed by the print function expansion unit 206 of the expansion application 204 will be described using a flowchart shown in FIG. 7. Each step of the flowchart shown in FIG. 7 is achieved by the CPU 111 activating the expansion application 204 in the host computer 101. In the following, a case where the printer 102 supports the auto photo image correction function, the face correction function, and the red-eye correction function as the photo correction functions will be described.

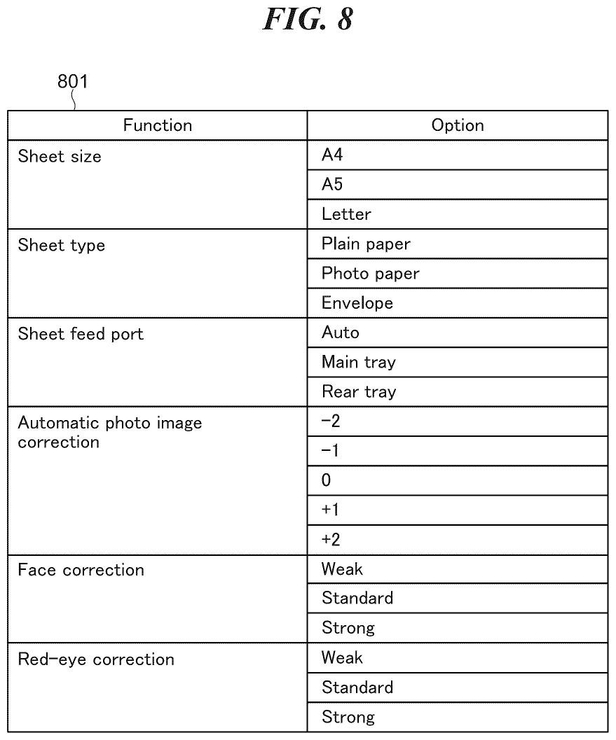

When the process of the flowchart shown in FIG. 7 is started, the CPU 111 obtains the capability information from the printing apparatus 102 with the print function expansion unit 206 in a step S701. The capability information includes attribute information that indicates a function settable in the printing apparatus 102 and is included in a response obtained by issuing a Get-Printer-Attributes operation of the IPP to the printing apparatus 102 and a set values related to the attribute information. FIG. 8 is a view illustrating an example of a list of capability information obtained from the printing apparatus 102 as a table. The print function expansion unit 206 can obtain options that can be set for each of the automatic photo image correction function, the face correction function, and the red-eye correction function from the printing apparatus 102 as shown in the table 801. The capability information of the printing apparatus 102 is stored in the shared information 209.

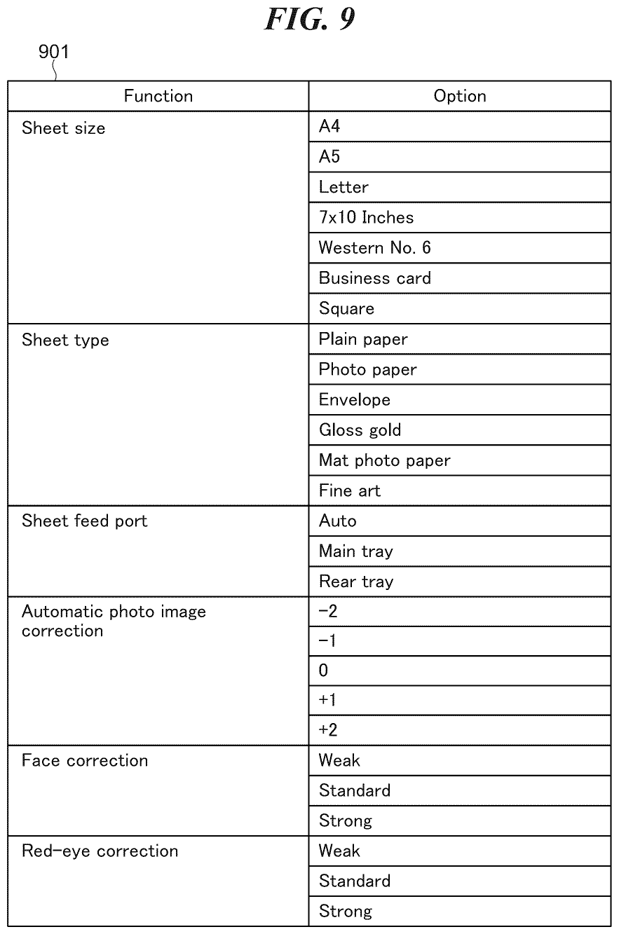

Referring back to the description of FIG. 7. Next, in a step S702, the CPU 111 obtains a list of the print functions supported by the expansion application 204 (hereinafter, also referred to as “capability information of the expansion application 204”) from the shared information 209 with the print function expansion unit 206. The list of the print functions supported by the expansion application 204 describes all print functions that can be processed by the expansion application 204 and their set values, and is stored in the shared information 209. A table 901 illustrated in FIG. 9 is an example of a list of print functions supported by the expansion application 204. The list of the print functions supported by the expansion application 204 may be updated according to update of the expansion application 204.

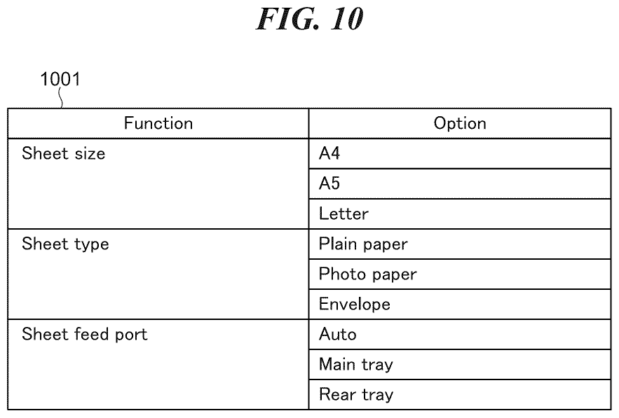

Referring back to the description of FIG. 7. Subsequently, in a step S703, the CPU 111 obtains the PDC 203 generated by the general-purpose print software 202 from the OS with the print function expansion unit 206. A table 1001 illustrated in FIG. 10 is an example of a list of the print functions supported by the general-purpose print software 202 (hereinafter, also referred to as “capability information of the general-purpose print software 202”). The PDC 203 generated by the general-purpose print software 202 is generated based on the table 801 that is the list of the capability information obtained by the general-purpose print software 202 from the printing apparatus 102. Since only the print functions supported by the general-purpose print software 202 are described in the PDC 203 generated by the general-purpose print software 202 among the capability information obtained from the printing apparatus 102, the functions of the PDC 203 are limited.

For example, the table 901, which is the list of the print functions supported by the expansion application 204, includes options of “7×10 Inches” and “Western No. 6” as the sheet size. However, the general-purpose print software 202 does not support these options, and the options are not described in the PDC 203. Since the general-purpose print software 202 does not support the photo correction functions, the PDC 203 does not describe the functions of the “automatic photo image correction”, “face correction”, and “red-eye correction”. Therefore, the print function expansion unit 206 adds a function or an option thereof to the PDC 203, and thus the expansion application 204 can compensate for function shortage of the general-purpose print software 202. The print function expansion unit 206 may also delete unnecessary functions and options from the PDC 203 generated created by the general-purpose print software 202.

Referring back to the description of FIG. 7. Subsequent steps S704, S705, and S706 are processes repeatedly performed for the list of functions and options included in the capability information obtained from the printing apparatus 102 in the step S701. That is, the processes in the steps S704, S705, and S706 are repeatedly performed for the list of functions and options of the table 801. First, in the step S704, the CPU 111 determines, with the print function expansion unit 206, whether the combination of the function and option in processing is included in the PDC 203 generated by the general-purpose print software 202. Note that the combination of the function and the option is described as “FUNCTION/OPTION” in the drawings.

When the CPU 111 determines, with the print function expansion unit 206, that the combination of the function and option in processing is included in the PDC 203 generated by the general-purpose print software 202, the process returns to the step S704. At this time, the CPU 111 selects, with the print function expansion unit 206, the next combination from the combinations of the functions and options of the capability information obtained from the printing apparatus 102 and performs the process in the step S704 again. However, when the CPU 111 determines, with the print function expansion unit 206, that the last combination among the combinations of the functions and options included in the capability information obtained from the printing apparatus 102 is under processing, the CPU 111 ends the process of the flowchart shown in FIG. 7. On the other hand, if the CPU 111 determines, with the print function expansion unit 206, that the combination of the function and option in processing is not included in the PDC 203 generated by the general-purpose print software 202, the process proceeds to a step S705.

For example, “Sheet size: A4” shown in the table 801, which is the list of the capability information of the printing apparatus 102, is also included in the table 1001, which is the list of the capability information of the general-purpose print software 202. In this case, the CPU 111 determines, with the print function expansion unit 206, that the combination of the function and option in processing is included in the PDC 203 generated by the general-purpose print software 202. In contrast, “Automatic photo image correction: +1” shown in the table 801, which is the list of the capability information of the printing apparatus 102, is not included in the table 1001, which is the list of the capability information of the general-purpose print software 202. In this case, the CPU 111 determines, with the print function expansion unit 206, that the combination of the function and option in processing is not included in the PDC 203 generated by the general-purpose print software 202. As a result, the process proceeds to the step S705.

Next, in the step S705, the CPU 111 determines, with the print function expansion unit 206, whether the combinations of the functions and options supported by the expansion application 204 include the combination of the function and option in processing. When the CPU 111 determines, with the print function expansion unit 206, that the combinations of the functions and options supported by the expansion application 204 include the combination of the function and option in processing, the process proceeds to a step S706. On the other hand, when the CPU 111 determines, with the print function expansion unit 206, that the combinations of the functions and options supported by the expansion application 204 do not include the combination of the function and option in processing, the process returns to the step S704. At this time, the CPU 111 selects, by the print function expansion unit 206, the next items from the functions and options of the capability information obtained from the printing apparatus 102 and performs the process in the step S704 again. However, when the last item among the combinations of functions and options included in the capability information obtained from the printing apparatus 102 is under processing by the print function expansion unit 206, the CPU 111 ends the process of the flowchart shown in FIG. 7.

Specifically, for example, when the combination of the function and option in processing is “Automatic photo image correction: +1”, the combination is also included in the table 901, which is the list of the capability information of the expansion application 204. In this case, the CPU 111 determines, with the print function expansion unit 206, that the combination of the function and option in processing is included in the combinations of the functions and options supported by the expansion application 204. As a result, the process proceeds to the step S706.

Subsequently, in the step S706, the CPU 111 adds, with the print function expansion unit 206, the combination of the function and option in processing to the PDC 203. Thereafter, the process returns to the step S704. At this time, the CPU 111 selects, with the print function expansion unit 206, the next combination from the combinations of the functions and options of the capability information obtained from the printing apparatus 102 and performs the process in the step S704 again. However, when the CPU 111 determines, with the print function expansion unit 206, that the last combination among the combinations of the functions and options included in the capability information obtained from the printing apparatus 102 is under processing, the CPU 111 ends the process of the flowchart shown in FIG. 7.

As described above, the CPU 111 adds, with the print function expansion unit 206, the combination of the function and option, which is not supported by the general-purpose print software 202 and is supported by the printing apparatus 102 and the expansion application 204, to the PDC 203. Specifically, “Automatic photo image correction: −2”, “Automatic photo image correction: −1”, “Automatic photo image correction: 0”, “Automatic photo image correction: +1”, and “Automatic photo image correction: +2” are added to the PDC 203. In addition, “Face correction: Weak”, “Face correction: Standard”, and “Face correction: Strong” are added to the PDC 203. Further, “Red-eye correction: Weak”, “Red-eye correction: Standard”, and “Red-eye correction: Strong” are added to the PDC 203.

The PC is generated on the basis of the PDC 203 edited by such an editing process flow. Further, the print-setting-screen expansion unit 205 generates the advanced setting screen on the basis of the PC generated. As a result, the function that is not supported by the general-purpose print software 202 is added, and its options to be displayed are added, so that the advanced setting screens in FIGS. 6C and 6D can be displayed.

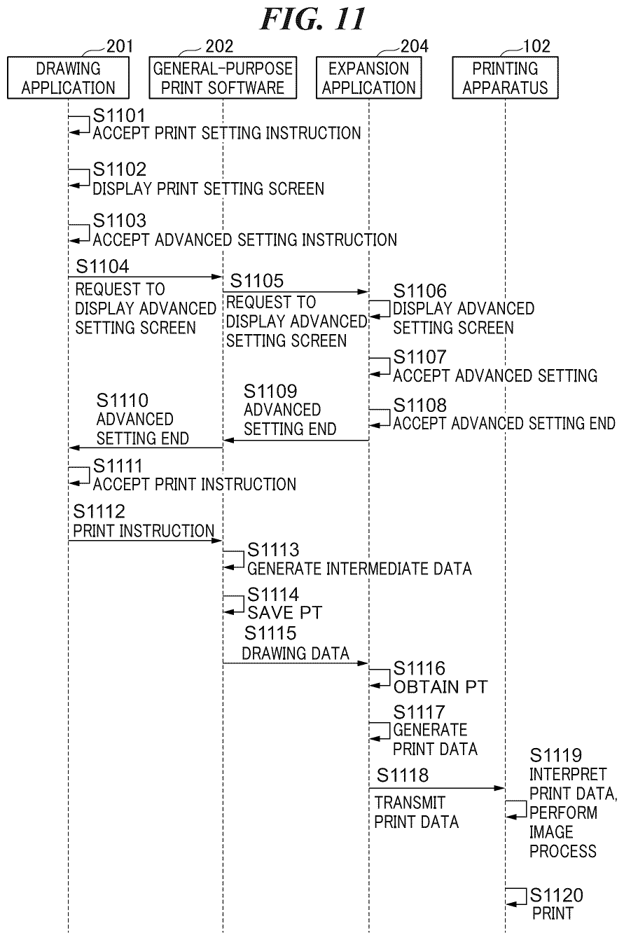

Next, a sequence (method) of the drawing application 201, the general-purpose print software 202, the expansion application 204, and the printing apparatus 102 after the drawing application 201 accepts the print setting instruction will be described with reference to FIG. 11. Steps other than the steps executed by the printing apparatus 102 in FIG. 11 are achieved by the CPU 111 (a computer) activating the drawing application 201, the general-purpose print software 202, and the expansion application 204 in the host computer 101. On the other hand, each step of the printing apparatus 102 in FIG. 11 is implemented by the ASIC 135 having a photo correction module in the printing apparatus 102, but may be implemented by the CPU 131 reading a program stored in the ROM 132 onto the RAM 133 and executing the program. The sequence in FIG. 11 assumes that the software configuration of the print system has the configuration in FIG. 2B.

First, in a step S1101, the CPU 111 of the host computer 101 accepts the print setting instruction from a user with the drawing application 201. The user can instruct the drawing application 201 to issue the print setting instruction by operating the keyboard 118 or the pointing device 119. Next, in a step S1102, the CPU 111 displays, with the drawing application 201, the print setting screen shown in FIG. 6A on the display unit 120. Subsequently, in a step S1103, the CPU 111 accepts, with the drawing application 201, an advanced setting instruction. The user can issue the advanced setting instruction by operating the pointing device 119 to select the control 605.

Next, in a step S1104, the CPU 111 requests, with the drawing application 201, the general-purpose print software 202 to display the advanced setting screen. Subsequently, in a step S1105, the CPU 111 requests, with the general-purpose print software 202, the expansion application 204 to display the advanced setting screen. Unlike the assumption, if the software configuration of the print system has the configuration in FIG. 2A, the general-purpose print software 202 displays the advanced setting screen shown in FIG. 6B on the display unit 120 as described above. Next, in a step S1106, the CPU 111 displays the advanced setting screen shown in FIG. 6C on the display unit 120 with the print-setting-screen expansion unit 205 of the expansion application 204 (a display step).

As described in the description about FIGS. 6C and 6D, the photo correction functions have been added to the PDC 203 with the print function expansion unit 206. Therefore, in the step S1106, the print-setting-screen expansion unit 205 displays the advanced setting screen shown in FIG. 6C on the display unit 120 with reference to the PC generated based on the PDC 203 following addition. Further, when the user selects the controls 610 and 613 by operating the pointing device 119, the print-setting-screen expansion unit 205 displays the advanced setting screen shown in FIG. 6D on the display unit 120 with reference to the PC generated based on the PDC 203 following addition.

Subsequently, in a step S1107, the CPU 111 accepts the advanced setting with the print-setting-screen expansion unit 205. In the case of the advanced setting screens shown in FIGS. 6C and 6D, the print-setting-screen expansion unit 205 accepts that “Sheet type: Plain paper”, “Sheet size: A4”, “Sheet feed port: Auto”, and “Automatic photo image correction: +1” are set by the user. Next, in a step S1108, the CPU 111 receives the advanced setting end with the print-setting-screen expansion unit 205. The user can instruct the advanced setting end by operating the pointing device 119 to select the control 609. When receiving the advanced setting end, the print-setting-screen expansion unit 205 closes the advanced setting screens in FIGS. 6C and 6D displayed on the display unit 120. As a result, the print setting screen illustrated in FIG. 6A is displayed on the display unit 120 again.

Subsequently, in a step S1109, the CPU 111 transmits, with the expansion application 204, the advanced setting end to the general-purpose print software 202. Next, in a step S1110, the CPU 111 transmits the advanced setting end to the drawing application 201 with the general-purpose print software 202. Subsequently, in a step S1111, the CPU 111 accepts, with the drawing application 201, a print instruction. The user can issue the print instruction by operating the pointing device 119 to select the control 603. Next, in a step S1112, the CPU 111 issues, with the drawing application 201, the print instruction to the general-purpose print software 202.

Subsequently, in a step S1113, the CPU 111 generates the intermediate data with the general-purpose print software 202. At this time, the general-purpose print software 202 uses a module of the OS. Next, in a step S1114, the CPU 111 stores, with the general-purpose print software 202, the PT included in the intermediate data in the shared information 209. Subsequently, in a step S1115, the CPU 111 transfers, with the general-purpose print software 202, the drawing data included in the intermediate data to the expansion application 204. Next, in a step S1116, the CPU 111 obtains, with the intermediate data editing unit 207 of the expansion application 204, the PT stored in the step S1114 from the shared information 209.

Subsequently, in a step S1117, the CPU 111 generates, with the intermediate image editing unit 207, the print data by using the drawing data and the PT (i.e., the intermediate data) (a generation step). Next, in a step S1118, the CPU 111 transmits, with the intermediate-data editing unit 207, the print job to the printing apparatus 102 (a transmission step). Next, in a step S1119, the ASIC 135 of the printing apparatus 102 interprets the print data with the photo correction module and performs a necessary image process on a photo image of the print data. For example, when the setting shown in FIGS. 6C and 6D are set, the ASIC 135 of the printing apparatus 102 performs the image process of the automatic photo image correction of “+1” with the photo correction module. Next, in a step S1120, the ASIC 135 of the printing apparatus 102 prints the print data subjected to the image process in the step S1119.

As described above, the CPU 111 of the host computer 101 corrects the PDC 203 with the print function expansion unit 206 of the expansion application 204 (the step S706). At this time, the print function expansion unit 206 corrects the PDC 203 on the basis of the capability information of the printing apparatus 102, the general-purpose print software 202, and the expansion application 204. Further, when the user issues the advanced setting instruction, the CPU 111 refers, with the print-setting-screen expansion unit 205 of the expansion application 204, to the PC generated on the basis of the PDC 203 and displays the advanced setting screens shown in FIGS. 6C and 6D (the step S1106). Accordingly, the print-setting-screen expansion unit 205 can receive the photo correction setting by the user (the step S1107).

Further, the CPU 111 generates, with the intermediate data editing unit 207 of the expansion application 204, the print data on the basis of the photo correction setting set so as to include the photo correction setting in the print data (the step S1117). After that, upon receiving the print data including the photo correction setting from the expansion application 204, the printing apparatus 102 performs, with the photo correction module of the ASIC 135, the photo correction based on the photo correction setting on the photo image of the print data (the step S1119). As described above, the expansion application 204 causes the printing apparatus 102 to achieve the photo correction function in the printing using the general-purpose printing software 202 that does not have the photo correction function. In this manner, the expansion application 204 can provide the user with the photo correction function.

In the first embodiment, the advanced setting screen shown in FIG. 6C is displayed on the display unit 120 (the step S1106) under the assumption that the software configuration of the print system has the configuration in FIG. 2B. This is not limited. For example, when the request to display the advanced setting screen is made in the step S1104, the CPU 111 of the host computer 101 may display the advanced setting screen of FIG. 6B on the display unit 120 with the general-purpose print software 202. In this case, after the setting on the advanced setting screen in FIG. 6B is completed, the CPU 111 requests, with the general-purpose print software 202, the expansion application 204 to additionally display the advanced setting screen. Further, the CPU 111 additionally displays, with the print-setting-screen expansion unit 205 of the expansion application 204, the advanced setting screen in FIG. 6C on which the photo correction setting is available.

In the first embodiment, the CPU 111 of the host computer 101 generates, with the intermediate data editing unit 207 of the expansion application 204, the print the data on the basis of the intermediate data generated by the general-purpose print software 202 (the step S1117). However, the CPU 111 may generate the intermediate data with the intermediate data editing unit 207 and generate the print data on the basis of the generated intermediate data.

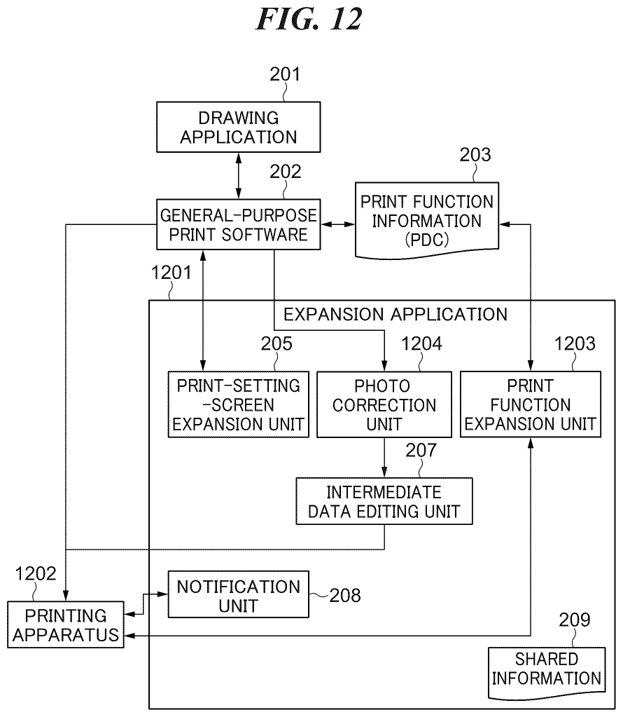

Hereinafter, a second embodiment will be described with reference to FIGS. 12 to 15. In the first embodiment, first, the CPU 111 of the host computer 101 generates, with the expansion application 204, the print data including the photo correction setting and transmits the generated print data to the printing apparatus 102 (the steps S1117 and S1118). The ASIC 135 of the printing apparatus 102 then interprets the print data including the photo correction setting and performs the photo correction with its photo correction module (the step S1119).

However, the printing apparatus may not include the photo correction module from the viewpoint of cost. In this case, even if the expansion application generates the print data including the photo correction setting, the printing apparatus cannot perform the photo correction. Therefore, when the photo correction module is not mounted on the printing apparatus, it is preferable that the expansion application generates the print data including the photo image after the photo correction and passes the generated print data to the printing apparatus.

Thus, in the second embodiment, the expansion application first determines from capability information of the printing apparatus whether the printing apparatus is equipped with the photo correction module. Next, when it is determined that the photo correction module is mounted on the printing apparatus, the expansion application generates the print data including the photo correction setting and passes the generated print data to the printing apparatus. On the other hand, when it is determined that the photo correction module is not mounted on the printing apparatus, the expansion application performs the photo correction on a photo image of drawing data. Subsequently, the expansion application generates the print data including the photo image after the photo correction, and passes the generated print data to the printing apparatus. As a result, the expansion application can provide the photo correction function to a user even when the printing apparatus is not equipped with the photo correction module.

The following description of the second embodiment is focused on the differences from the first embodiment. The same configurations and processes as those of the first embodiment are denoted by the same reference numerals in FIGS. 12 to 15 and the descriptions thereof will be omitted because they have been already described in the first embodiment. The second embodiment differs from the first embodiment in four points, i.e., the software configuration of the print system, the editing process of the PDC, the capability information of the printing apparatus, and the sequence after the drawing application receives the print setting instruction.

FIG. 12 is a block diagram illustrating a software configuration of a print system in which an expansion application 1201 in the second embodiment is associated with the general-purpose print software 202 and a printing apparatus 1202. The printing apparatus 1202 is similar to the printing apparatus 102 of the first embodiment except that the printing apparatus 1202 does not include the photo correction module. That is, the ASIC 135 of the printing apparatus 1202 of the second embodiment has no photo correction module.

The expansion application 1201 (an application program) includes the print-setting-screen expansion unit 205, the intermediate data editing unit 207, the notification unit 208, the shared information 209, a print function expansion unit 1203, and a photo correction unit 1204. Unlike the first embodiment, even when the capability information obtained from the printing apparatus 1202 does not have the photo correction function, if the expansion application 1201 has a unit or a module for performing photo correction, the print function expansion unit 1203 adds the photo correction function to the PDC 203. The photo correction unit 1204 performs the photo correction on the photo image of the intermediate data (drawing data) obtained from the general-purpose print software 202 on the basis of the photo correction setting set by the user. Accordingly, the photo correction unit 1204 corresponds to a unit that performs the photo correction. The expansion application 1201 is stored in the external storage device 114 of the host computer 101.

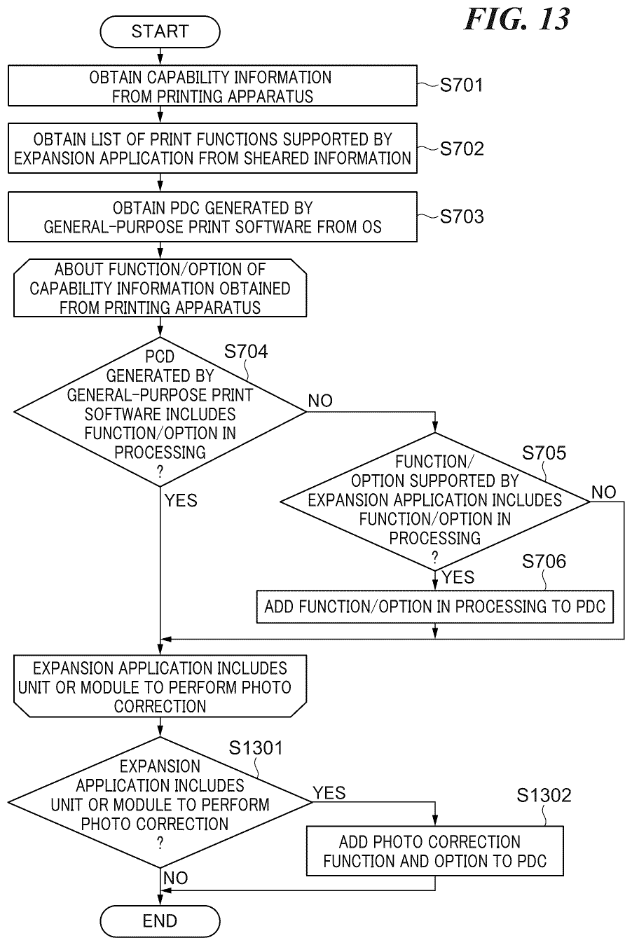

An editing process for the PDC 203 performed by the print function expansion unit 1203 of the expansion application 1201 will be described using a flowchart shown in FIG. 13. Each step of the flowchart shown in FIG. 13 is achieved by the CPU 111 activating the expansion application 1201 in the host computer 101. The flowchart in FIG. 13 is obtained by adding processes in steps S1301 and S1302 to the flowchart in FIG. 7.

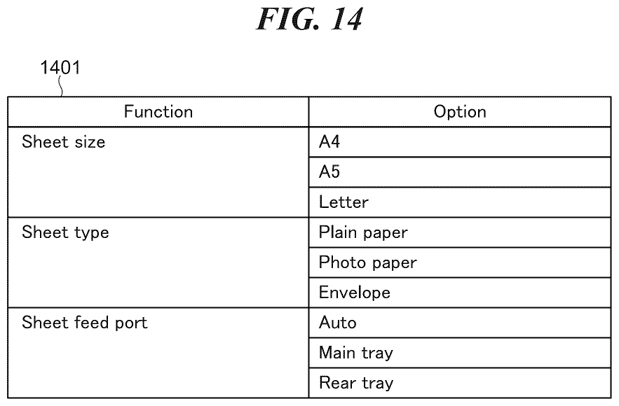

However, in step S701, the CPU 111 of the host computer 101 obtains capability information different from that of the first embodiment from the printing apparatus 1202 with the print function expansion unit 1203. FIG. 14 is a view illustrating an example of a list of capability information obtained from the printing apparatus 1202 as a table 1401. As described above, the printing apparatus 1202 includes no photo correction module. Thus, the print function expansion unit 1203 cannot obtain the photo correction functions and their options from the printing apparatus 1202, as shown in table 1401, unlike the table 801 in the first embodiment. Therefore, at the time when the repetitive process from the step S704 to the step S706 is completed, the automatic photo image correction function, the face correction function, and the red-eye correction function are not added to the PDC 203.

When the repetitive process from the step S704 to the step S706 is completed, the process proceeds to a step S1301. In the step S1301, the CPU 111 determines, with the print function expansion unit 1203, whether the expansion application 1201 includes a unit or module to perform the photo correction. When the CPU 111 determines, with the print function expansion unit 1203, that the expansion application 1201 includes no unit or module to perform the photo correction, the process of the flowchart in FIG. 13 ends. On the other hand, when the CPU 111 determines, with the print function expansion unit 1203, that the expansion application 1201 includes a unit or module that performs the photo correction, the process proceeds to a step S1302. In the second embodiment, since the expansion application 1201 has the photo correction unit 1204, the process proceeds to the step S1302.

In the step S1302, the CPU 111 adds, with the print function expansion unit 1203, the photo correction functions and their options in the table 901, which is the list of the capability information of the expansion application 1201, to the PDC 203. Specifically, “Automatic photo image correction: −2”, “Automatic photo image correction: −1”, “Automatic photo image correction: 0”, “Automatic photo image correction: +1”, and “Automatic photo image correction: +2” in the table 901 are added to the PDC 203. In addition, “Face correction: Weak”, “Face correction: Standard”, and “Face correction: Strong” are added to the PDC 203. Further, “Red-eye correction: Weak”, “Red-eye correction: Standard”, and “Red-eye correction: Strong” are added to the PDC 203. Thereafter, the process of the flowchart in FIG. 13 ends.

As described above, the CPU 111 first adds, with the print function expansion unit 1203, functions and options that are not supported by the general-purpose print software 202 and are supported by the printing apparatus 1202 and the expansion application 1201. Further, when it is determined that the expansion application 1201 includes a unit or module to perform the photo correction, the print function expansion unit 1203 adds the photo correction functions and their options supported by the expansion application 1201 to the PDC 203. Accordingly, even when the printing apparatus 1202 includes no photo correction module, the CPU 111 can display, with the print-setting-screen expansion unit 205, the advanced setting screens in FIGS. 6C and 6D on the display unit 120 by referring to the PC generated on the basis of the PDC 203.

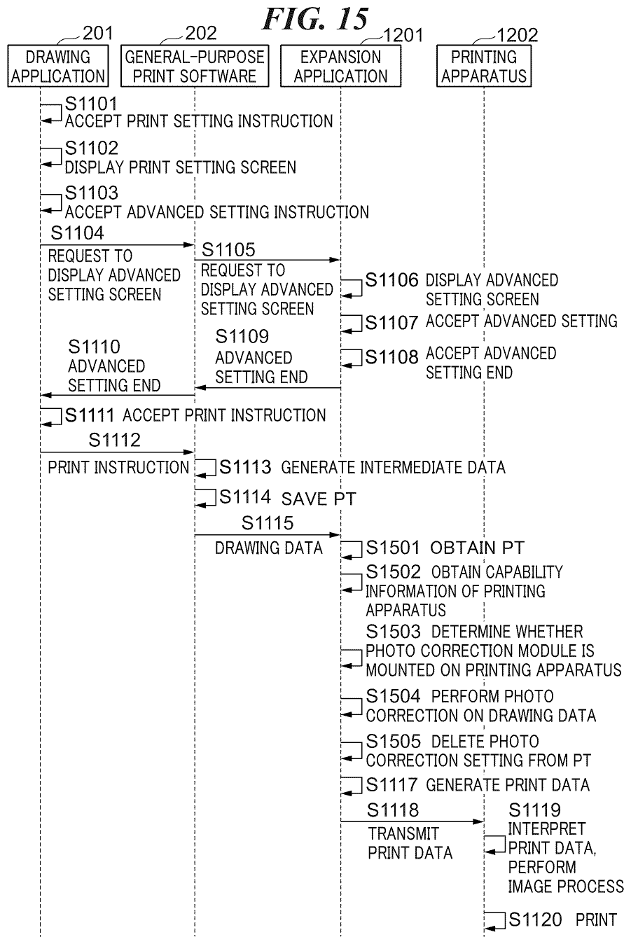

Next, a sequence of the drawing application 201, the general-purpose print software 202, the expansion application 1201, and the printing apparatus 1202 after the drawing application 201 accepts the print setting instruction will be described using FIG. 15. Steps other than the steps executed by the printing apparatus 1202 in FIG. 15 are achieved by the CPU 111 activating the drawing application 201, the general-purpose print software 202, and the expansion application 1201 in the host computer 101. On the other hand, each step of the printing apparatus 1202 in FIG. 15 is implemented by the ASIC 135 having no photo correction module in the printing apparatus 1202. The sequence in FIG. 15 assumes that the list of the capability information of printing apparatus 1202 is the table 1401 and the software configuration of the print system has the configuration in FIG. 12.

The sequence in FIG. 15 is obtained by adding processes in steps S1501 to S1505 instead of the process in the step S1116 to the sequence in FIG. 11. In the step S1501 after the process in the step S1115, the CPU 111 obtains, with the photo correction unit 1204 of the expansion application 1201, the PT saved in the step S1114 from the shared information 209. Accordingly, the photo correction unit 1204 obtains the photo correction setting. Next, in the step S1502, the CPU 111 obtains, with the photo correction unit 1204, the capability information of the printing apparatus 1202 from the shared information 209. If the capability information of the printing apparatus 1202 is not included in the shared information 209, the CPU 111 may store, with the print function expansion unit 1203 of the expansion application 1201, the capability information of the printing apparatus 1202 obtained from the printing apparatus 1202 in the shared information 209.

Subsequently, in the step S1503, the CPU 111 determines, with the photo correction unit 1204, whether a photo correction module is mounted on the printing apparatus 1202. The photo correction unit 1204 makes this determination on the basis of the capability information of the printing apparatus 1202 obtained in the step S1502. In this regard, the printing apparatus 1202 includes no photo correction module as described above. Thus, in the step S1503, the CPU 111 determines, with the photo correction unit 1204, that no photo correction module is mounted on the printing apparatus 1202. Thereafter, the process proceeds to the step S1504.

Unlike the printing apparatus 1202 in the second embodiment, if the CPU 111 determines, with the photo correction unit 1204, that a photo correction module is mounted on the printing apparatus 1202 in the step S1503, the process skips the steps S1504 and S1505 and proceeds to the step S1117. This is because the photo correction module mounted on the printing apparatus 1202 can perform, with the ASIC 135 having the photo correction module, the photo correction at a higher speed than the photo correction unit 1204 of the expansion application 1201.

Next, in the step S1504, the CPU 111 performs, with the photo correction unit 1204, the photo correction on the photo image in the drawing data on the basis of the photo correction setting obtained in the step S1501, and stores the drawing data subjected to the photo correction in the shared information 209. Subsequently, in the step S1505, the CPU 111 deletes, with the photo correction unit 1204, the photo correction setting from the PT.

As described above, the CPU 111 of the host computer 101 determines, with the photo correction unit 1204 of the expansion application 1201, whether the photo correction module is mounted on the printing apparatus 1202 (the step S1503). At this time, unlike the printing apparatus 1202 in the second embodiment, if the photo correction unit 1204 determines that the photo correction module is mounted on the printing apparatus 1202, the photo correction is not performed. Then, the CPU 111 generates, with the intermediate data editing unit 207 of the expansion application 1201, the print data including the photo correction setting in the same manner as the first embodiment (the step S1117). Further, the intermediate data editing unit 207 transmits the generated print data to the printing apparatus 1202 (the step S1118).

On the other hand, when it is determined that no photo correction module is mounted on the printing apparatus 1202, the photo correction unit 1204 performs the photo correction on the photo image in the drawing data (the step S1504). Then, unlike the first embodiment, the CPU 111 generates, with the intermediate data editing unit 207 of the expansion application 1201, the print data including the image after the photo correction (the step S1117). Further, the intermediate data editing unit 207 transmits the generated print data to the printing apparatus 1202 (the step S1118).

As described above, even when no photo correction module is mounted on the printing apparatus 1202, the expansion application 1201 causes the printing apparatus 1202 to achieve the photo correction function in printing using the general-purpose print software 202 that has no photo correction function. In this manner, the expansion application 1201 can provide the user with the photo correction function.

Unlike the printing apparatus 1202 in the second embodiment, if a photo correction module is mounted on the printing apparatus 1202, the printing apparatus 1202 performs the photo correction. However, even if the photo correction module is mounted on the printing apparatus 1202, for example, when free space of an image processing memory (for example, the RAM 133) included in the printing apparatus 1202 is small, the expansion application 1201 may perform the photo correction. This is because it is preferable that the data of the entire image is developed on the memory in the image analysis necessary for the photo correction.

More specifically, for example, when the free space of the image processing memory is smaller than a capacity (hereinafter, referred to as a “predetermined capacity”) in which the data of the entire image can be developed, the photo correction is performed for each divided data obtained by dividing the data of the entire image. However, the divided data is difficult to generate an accurate histogram of the brightness value (Y value) of the entire image. This may result in a poor image analysis and cannot provide the desired photo correction. Therefore, the CPU 111 of the host computer 101 obtains, with the print function expansion unit 1203 of the expansion application 1201, the information about the free space of the image processing memory of the printing apparatus 1202 from the printing apparatus 1202. Further, when the expansion application 1201 determines that the free space of the image processing memory of the printing apparatus 1202 is smaller than the predetermined capacity and the data of the entire image cannot be developed on the memory on the basis of the obtained free space information, the photo correction unit 1204 performs the photo correction.

In the second embodiment, when it is determined that no photo correction module is mounted on the printing apparatus 1202, the photo correction unit 1204 of the expansion application 1201 performs the photo correction on the photo image in the drawing data (the step S1504). In this regard, if achievement of high-speed photo correction is not important, the photo correction unit 1204 may perform the photo correction on the photo image in the drawing data regardless of whether the photo correction module is mounted on the printing apparatus 1202. In this case, the processes in the steps S1502 and S1503 are omitted. In the following description, when the former and the latter are distinguished from each other, the former is described as “the second embodiment (the mount of the photo correction module is determined)”, and the latter is described as “the second embodiment (the mount of the photo correction module is not determined)”.

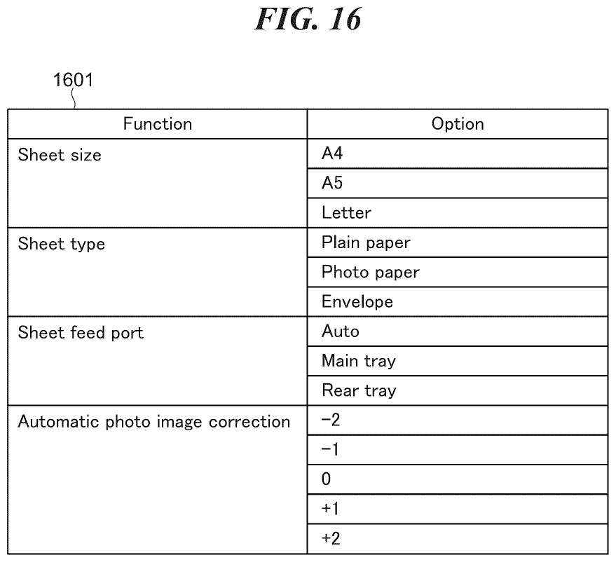

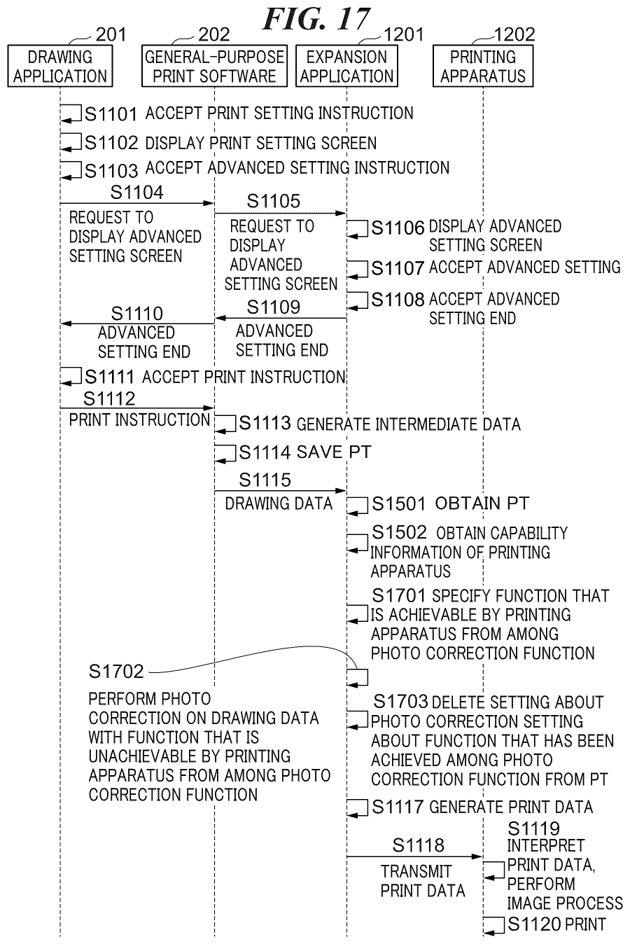

Hereinafter, a third embodiment will be described with reference to FIGS. 16 and 17. The case where the printing apparatus 102 performs the photo correction has been described in the first embodiment, and the case where the expansion application 1201 performs the photo correction has been described in the second embodiment. However, there may be a case where the printing apparatus can achieve only a part of the photo correction functions. For example, this is a case where the printing apparatus can achieve only the automatic photo image correction function among the automatic photo image correction function, the face correction function, and the red-eye correction function.

In such a case, the automatic photo image correction function may be also achieved by the expansion application as in the case of the second embodiment, similarly to the face correction function and the red-eye correction function. However, the automatic photo image correction function that can be achieved by the printing apparatus is often achieved by a dedicated module therefor, and thus, there is a high possibility that the automatic photo image correction function is achieved at a higher speed than the expansion application. Therefore, when considering the performance in printing, it is preferable that the automatic photo image correction function that can be achieved by the printing apparatus is achieved by the printing apparatus concerned. Therefore, a method in which a first function that can be achieved by the printing apparatus among the photo correction functions is achieved by the printing apparatus and a second function that cannot be achieved by the printing apparatus among the photo correction functions is achieved by the expansion application will be described in the third embodiment.

The following description of the third embodiment is focused on the differences from the second embodiment. The same configurations and processes as those of the second embodiment are denoted by the same reference numerals in FIG. 17 and the descriptions thereof will be omitted because they have been already described in the second embodiment. The third embodiment differs from the second embodiment in two points, i.e., the capability information of the printing apparatus and the sequence after the drawing application accepts the print setting instruction.

FIG. 16 is a view illustrating an example of a list of capability information obtained from the printing apparatus 1202 as a table 1601. The table 1601 shows that the capability information of the printing apparatus 1202 includes the automatic photo image correction function and the options thereof. Thus, the automatic photo image correction function and its options are added to the PDC 203 in the step S706 of the editing process for the PDC 203. Further, the face correction function and its options, and the red-eye correction function and its options in the table 901, which is the list of capability information of the expansion application 1201, are added to the PDC 203 in the step S1302 of the editing process for the PDC 203.

Next, a sequence of the drawing application 201, the general-purpose print software 202, the expansion application 1201, and the printing apparatus 1202 after the drawing application 201 accepts the print setting instruction will be described using FIG. 17. Steps other than the steps executed by the printing apparatus 1202 in FIG. 17 are achieved by the CPU 111 activating the drawing application 201, the general-purpose print software 202, and the expansion application 1201 in the host computer 101. On the other hand, each step of the printing apparatus 1202 in FIG. 17 is achieved by the ASIC 135 having a photo correction module capable of performing only the automatic photo image correction in the printing apparatus 1202. The sequence in FIG. 17 assumes that the list of the capability information of printing apparatus 1202 is the table 1601 and the software configuration of the print system has the configuration in FIG. 12. Therefore, a case where the face correction function and the red-eye correction function among the photo correction functions are achieved by the expansion application 1201 and the automatic photo image correction function is achieved by the printing apparatus 1202 will be described below.

The sequence in FIG. 17 is obtained by adding processes in steps S1701 to S1703 instead of the process in the steps S1503 to S1505 the sequence in FIG. 15. In the step S1701 after the process in the step S1502, the CPU 111 specifies, with the photo correction unit 1204 of the expansion application 1201, a function that is achievable by the printing apparatus 1202 from among the photo correction functions. The photo correction unit 1204 specifies the function on the basis of the capability information of the printing apparatus 1202 obtained in the step S1502. The ASIC 135 of the printing apparatus 1202 has the photo correction module capable of performing only the automatic photo image correction. Therefore, in the step S1701, the automatic photo image correction function among the photo correction functions is specified as a function that is achievable by the printing apparatus 1202. As a result, the face correction function and the red-eye correction function among the photo correction functions are specified as functions that are not achievable by the printing apparatus 1202.

In the step S1702, the CPU 111 achieves, with the photo correction unit 1204, the function that is unachievable by the printing apparatus 1202 among the photo correction functions, and performs the photo correction on the photo image of the drawing data. Further, the photo correction unit 1204 stores the drawing data that has been subjected to the photo correction in the shared information 209. Specifically, the photo correction unit 1204 performs the face correction and the red-eye correction on the photo image in the drawing data on the basis of the face correction setting and the red-eye correction setting included in the PT obtained in the step S1501 and stores the corrected drawing data in the shared information 209. Subsequently, in the step S1703, the CPU 111 deletes, with the photo correction unit 1204, the setting about the function achieved in the step S1702 among the photo correction functions from the PT.

As described above, the CPU 111 of the host computer 101 performs the photo correction with the photo correction unit 1204 of the expansion application 1201 (step S1702). At this time, the photo correction unit 1204 achieves the functions (that is, the face correction function and the red-eye correction function) that are unachievable by the printing apparatus 1202 among the photo correction functions, and performs the photo correction on the photo image in the drawing data (the step S1702). Further, the printing apparatus 1202 achieves the function that is achievable by the printing apparatus 1202 among the photo correction functions by the photo correction module included in the ASIC 135, and performs the photo correction on the photo image in the drawing data (the step S1119). Specifically, the printing apparatus 1202 performs the automatic photo image correction on the photo image of the print data on the basis of the automatic photo image correction setting included in the print data with the photo correction module included in the ASIC 135.

As described above, even when the photo correction module of the printing apparatus 102 cannot achieve a part of the photo correction functions, the expansion application 1201 achieves the photo correction function that is unachievable by the printing apparatus 1202 in printing using the general-purpose print software 202 that has not the photo correction function concerned. Thus, the expansion application 1201 can provide the photo correction function to the user and improve the print performance.

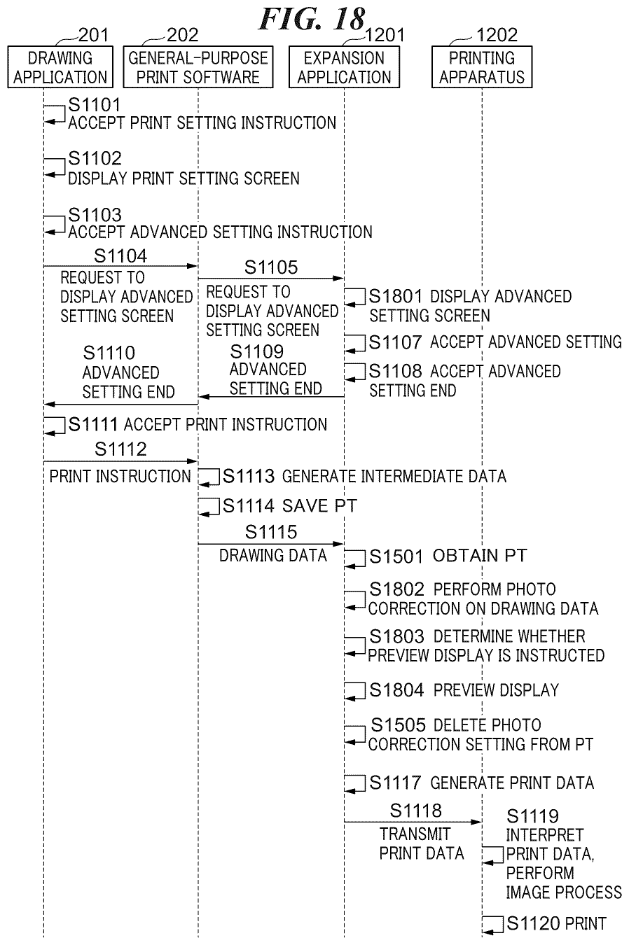

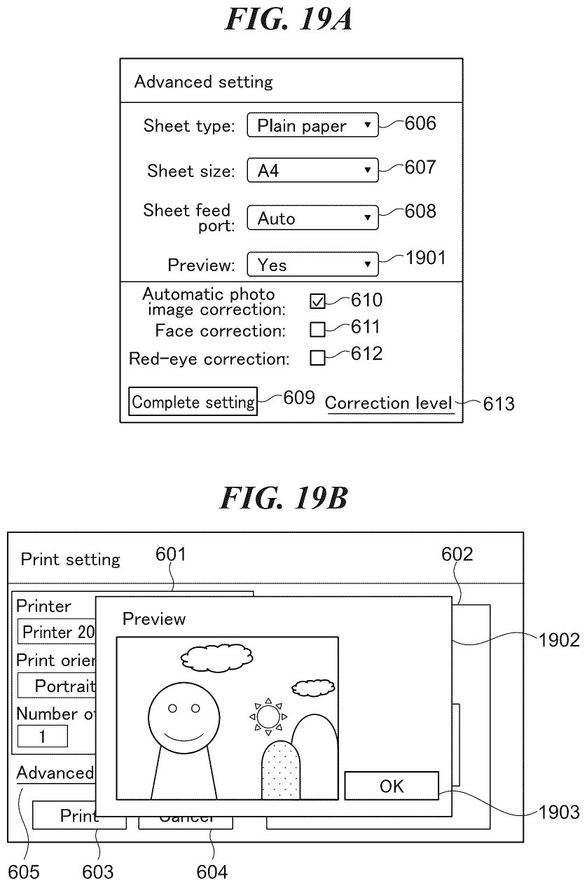

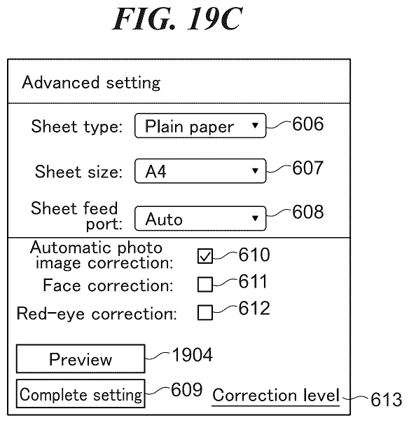

Hereinafter, a fourth embodiment will be described with reference to FIGS. 18 to 19C. For example, when a plurality of functions among the photo correction functions are combined and achieved, it is convenient for a user if a result of achievement can be checked before printing. Therefore, a method in which the expansion application displays a preview image to which a photo correction result is reflected will be described in the fourth embodiment. The following description of the fourth embodiment focuses only differences from the second embodiment. The same configurations and processes as those of the second embodiment are denoted by the same reference numerals in FIGS. 18 to 19C and the descriptions thereof will be omitted because they have been already described in the second embodiment. The fourth embodiment differs from the second embodiment in one point, i.e., the sequence after the drawing application accepts the print setting instruction.

Next, a sequence of the drawing application 201, the general-purpose print software 202, the expansion application 1201, and the printing apparatus 1202 after the drawing application 201 accepts the print setting instruction will be described using FIG. 18. Steps other than the steps executed by the printing apparatus 1202 in FIG. 18 are achieved by the CPU 111 activating the drawing application 201, the general-purpose print software 202, and the expansion application 1201 in the host computer 101. On the other hand, each step of the printing apparatus 1202 in FIG. 18 is achieved by the ASIC 135 having no photo correction module in the printing apparatus 1202. The sequence in FIG. 18 assumes that the list of the capability information of printing apparatus 1202 is the table 1401 and the software configuration of the print system has the configuration in FIG. 12.

The sequence in FIG. 18 is obtained by adding a process in a step S1801 instead of the process in the step S1106 to the sequence in FIG. 15 and adding processes in steps S1802 to S1804 instead of the processes in the steps S1502 to S1504 to the sequence in FIG. 15. In the step S1801 after the process in the step S1105, the CPU 111 displays, with the print-setting-screen expansion unit 205 of the expansion application 1201, an advanced setting screen shown in FIG. 19A on the display unit 120. The advanced setting screen (a reception screen) in FIG. 19A is obtained by adding a control 1901 to the advanced setting screen in FIG. 6C. The control 1901 is a drop-down list that allows a user to select whether to display a preview image and indicates that “YES” is set in FIG. 19A.

In the step S1802 after the process in the step S1501, the CPU 111 performs, with the photo correction unit 1204 of the expansion application 1201, the photo correction on the photo image in the drawing data on the basis of the photo correction setting obtained in the step S1501. Further, the photo correction unit 1204 stores the drawing data subjected to the photo correction in the shared information 209.

Subsequently, in the step S1803, the CPU 111 determines, with the print-setting-screen expansion unit 205, whether the preview display is instructed. The print-setting-screen expansion unit 205 makes this determination on the basis of the setting of the control 1901. When the CPU 111 determines, with the print-setting-screen expansion unit 205, that the preview display is instructed, that is, when the control 1901 is set to “YES”, the process proceeds to the step S1804. On the other hand, when the CPU 111 determines, with the print-setting-screen expansion unit 205, that the preview display is not instructed, that is, when the control 1901 is not set to “YES”, the step S1804 is skipped. Thereafter, the process proceeds to the step S1505.

In the step S1804, the CPU 111 displays a preview image with the print-setting-screen expansion unit 205. Specifically, as shown in FIG. 19B, the print-setting-screen expansion unit 205 displays the preview image of the photo image in the drawing data that has been subjected to the photo correction in a window of a control 1902 popped up over the print setting screen (display screen) in FIG. 6A. Note that a control 1903 displayed in the window of the control 1902 is an OK button. When the control 1903 is selected by the pointing device 119, the controls 1902 to 1903 are erased. Thereafter, the process proceeds to the step S1505.

As described above, the CPU 111 of the host computer 101 determines, with the print-setting-screen expansion unit 205 of the expansion application 1201, whether the preview display is instructed (the step S1803). At this time, when the print-setting-screen expansion unit 205 determines that the preview display is instructed, the print-setting-screen expansion unit 302 displays the preview image of the photo image in the drawing data subjected to the photo correction (the step S1804). By displaying the preview image in this manner, the expansion application 1201 allows the user to check the photo correction result before printing.

Although the preview image is displayed by the pop-up of the control 1902 over the print setting screen in the fourth embodiment, the present disclosure is not limited thereto. The preview image may be displayed in any form, and may be displayed by, for example, incorporating the preview image after the photo correction into the control 602 on the print setting screen (display screen).

In addition, although the user selects whether to display the preview image using the control 1901 in the list format in the fourth embodiment, the present disclosure is not limited thereto. For example, a control 1904 as a preview button may be displayed on an advanced setting screen (a reception screen) as shown in FIG. 19C. In this case, when the user selects the control 1904 with the pointing device 119, the preview display is instructed and the selection triggers the processes in the steps S1107 to S1804.

In addition, although the preview image is displayed on the print setting screen after the print instruction from the user is accepted in the step S1111, that is, after the control 603 on the print setting screen is selected in the fourth embodiment, the present disclosure is not limited thereto. For example, the preview image may be displayed on the advanced setting screen when the control 609, 610 to 612, 1901, or 1904 on the advanced setting screen is selected. In this case, the processes in the steps S1113 to S1804 are performed after the process in the step S1108, for example.

In addition, since the determination process in the step S1503 is not included in the fourth embodiment, the display of the preview image is applied to the second embodiment (the mount of the photo correction module is not determined). In this regard, the display of the preview image may be applied to the second embodiment (the mount of the photo correction module is determined). In this case, the processes in the steps S1803 and S1804 are performed, for example, between the steps S1504 and S1505 in FIG. 15.

The display of the preview image may also be applied to the first embodiment. In this case, the processes in the steps S1802 to S1804 are performed, for example, between the steps S1116 and S1117 in FIG. 11. In addition, the display of the preview image may also be applied to the third embodiment. In this case, the processes in the steps S1803 and S1804 are performed, for example, between the steps S1702 and S1703 in FIG. 17.

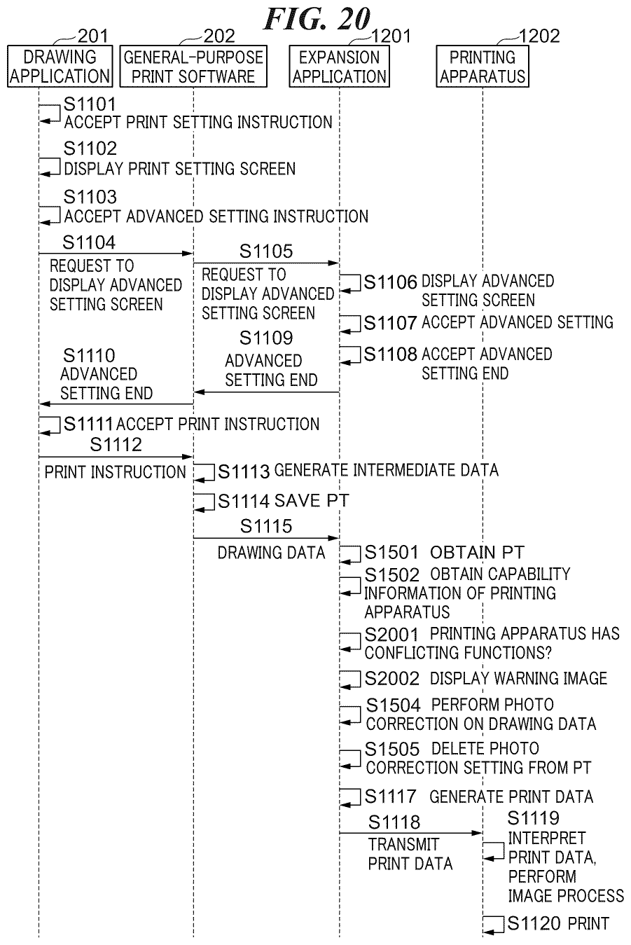

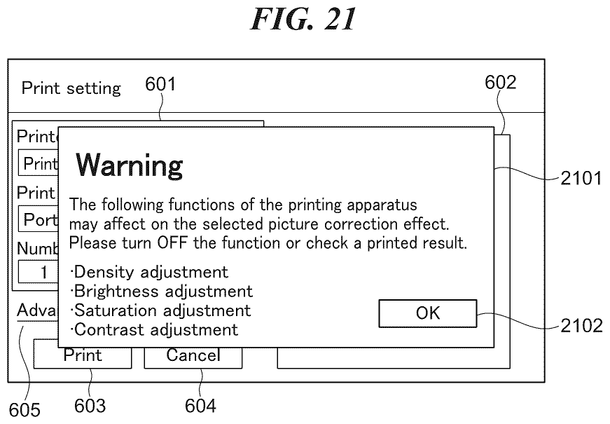

Hereinafter, a fifth embodiment will be described with reference to FIGS. 20 and 21. An effect of the photo correction by the expansion application may be cancelled by a color adjustment function of a printing apparatus. For example, if a process of increasing density (decreasing brightness) is performed by a printing apparatus, an effect of the face correction that brighten a face by the expansion application is canceled. However, the user cannot know that the effect of the face correction has been cancelled until the user views a printed result. Therefore, in the fifth embodiment, a method in which the expansion application issues a warning before printing to notify a user that a printing apparatus has a function that may cancel an effect of photo correction will be described.

The following description of the fifth embodiment is focused on the differences from the second embodiment. The same configurations and processes as those of the second embodiment are denoted by the same reference numerals in FIGS. 20 and 21 and the descriptions thereof will be omitted because they have been already described in the second embodiment. The fifth embodiment differs from the second embodiment in one point, i.e., the sequence after the drawing application accepts the print setting instruction.

A sequence of the drawing application 201, the general-purpose print software 202, the expansion application 1201, and the printing apparatus 1202 after the drawing application 201 accepts the print setting instruction will be described using FIG. 20. Steps other than the steps executed by the printing apparatus 1202 in FIG. 20 are achieved by the CPU 111 activating the drawing application 201, the general-purpose print software 202, and the expansion application 1201 in the host computer 101. On the other hand, each step of the printing apparatus 1202 in FIG. 20 is achieved by the ASIC 135 having no photo correction module in the printing apparatus 1202. The sequence in FIG. 20 assumes that the list of the capability information of printing apparatus 1202 is the table 1401 and the software configuration of the print system has the configuration in FIG. 12.

The sequence in FIG. 20 is obtained by adding processes in steps S2001 and S2002 instead of the process in the step S1503 to the sequence in FIG. 15. In the step S2001, the CPU 111 determines, with the print function expansion unit 1203 of the expansion application 1201, whether the printing apparatus 1202 has a function that may conflict with a function selected by the user from among the photo correction functions. For this determination, the print function expansion unit 1203 obtains function information about functions of the printing apparatus 1202 that conflict with the photo correction functions from the printing apparatus 1202 in the step S1502. Further, the print function expansion unit 1203 performs the determination in the step S2001 on the basis of the photo correction setting included in the PT obtained in the step S1501 and the function information obtained in the step S1502.

Specifically, when the automatic photo image correction function and the face correction function are selected by the user from among the photo correction functions, the brightness and vividness are mainly corrected by the automatic photo image correction function and the face correction function. Accordingly, in this case, a density adjustment function, a brightness adjustment function, a saturation adjustment function, and a contrast adjustment function may conflict with the function selected by the user from among the photo correction functions. Therefore, if the printing apparatus 1202 has any of the density adjustment function, the brightness adjustment function, the saturation adjustment function, and the contrast adjustment function, it is determined that the printing apparatus 1202 has a function that may conflict with the function selected by the user from among the photo correction functions.

In this way, when it is determined that the printing apparatus 1202 has a function (hereinafter referred to as a “conflicting function”) that may conflict with the function selected by the user from among the photo correction functions, the process proceeds to the step S2002. On the other hand, when it is determined that the printing apparatus 1202 has no conflicting function, the CPU 111 skips the step S2002. Thereafter, the process proceeds to the step S1504.

In the step S2002, the CPU 111 displays a warning image with the print-setting-screen expansion unit 205 of the expansion application 1201. Specifically, the print-setting-screen expansion unit 205 displays the warning image in a window of a control 2101 popped up over the print setting screen (display screen) in FIG. 6A as shown in FIG. 21. Note that a control 2102 displayed in the window of the control 2101 is an OK button. When the control 2102 is selected by the pointing device 119, the controls 2101 to 2102 are erased. Thereafter, the process proceeds to the step S1504.

As described above, the CPU 111 of the host computer 101 determines, with the print-setting-screen expansion unit 205 of the expansion application 1201, whether the printing apparatus 1202 has the conflicting function (the step S2101). At this time, when determining that the printing apparatus 1202 has the conflicting function, the print-setting-screen expansion unit 205 displays the warning image (the step S2002). As a result, the expansion application 1201 can notify the user that the printing apparatus 1202 has a function that may cancel an effect of photo correction with the expansion application 1201 by warning before printing.

Although the warning image is displayed in the pop-up of the control 2101 over the print setting screen in the fifth embodiment, the present disclosure is not limited thereto. The warning image may be displayed in any form, and may be displayed by, for example, incorporating the warning image into the control 602 on the print setting screen (display screen). In addition, although the density adjustment function, the brightness adjustment function, the saturation adjustment function, and the contrast adjustment function are described as examples of the conflicting functions in the fifth embodiment, the conflicting functions are not limited thereto, and may be any function that affects the function selected by the user from among the photo correction functions.

In the fifth embodiment, the CPU 111 of the host computer 101 only displays the warning image with the print-setting-screen expansion unit 205 of the expansion application 1201. However, the CPU 111 may cause the printing apparatus 1202 to turn off all functions that may conflict with the photo correction functions with the print function expansion unit 1203 of the expansion application 1201. Further, the CPU 111 may specify, with the print function expansion unit 1203, functions that may conflict with the function selected by the user from among the photo correction functions, and may cause the printing apparatus 1202 to turn off the specified functions.

In the fifth embodiment, the warning image is displayed after accepting the print instruction from the user in the step S1111, that is, after selecting the control 603 on the print setting screen, but this is not limited. For example, when the control 609, 610, or 612 on the advanced setting screen is selected, the warning image may be displayed over the advanced setting screen. In this case, the processes in the steps S2001 and S2002 are performed after the process in the step S1108.

Further, since the determination process in the step S1503 is not included in the fifth embodiment, the display of the warning image is applied to the second embodiment (the mount of the photo correction module is not determined). In this regard, the display of the warning image can also be applied to the second embodiment (the mount of the photo correction module is determined). In this case, the processes in the steps S2001 and S2002 are performed, for example, between the steps S1502 and S1504 in FIG. 15.

The display of the warning image can also be applied to the first embodiment. In this case, the processes in the steps S1502, S2001, and S2002 are performed, for example, between the steps S1116 and S1117 in FIG. 11. The display of the warning image can also be applied to the third embodiment. In this case, the processes in the steps S2001 and S2002 are performed, for example, between the steps S1502 and S1702 in FIG. 17. The display of the warning image can also be applied to the fourth embodiment. In this case, the processes in the steps S2001 and S2002 are performed, for example, between the steps S1501 and S1802 in FIG. 18.

According to the present disclosure, a photo correction function can be achieved in printing using a standard driver that does not have the photo correction function.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-188278, filed Oct. 25, 2024 which is hereby incorporated by reference herein in its entirety.

What is claimed is:

1. A non-transitory computer-readable storage medium storing a print application program, which supports a standard driver that is provided by a provider of an operating system and is built in the operating system in advance, causing a computer to execute a control method comprising:
displaying a screen to receive a setting to a photo correction function that is not provided by the standard driver on an information processing apparatus; and
causing the information processing apparatus to generate print data that causes a printing apparatus to execute the photo correction function with the setting received.

2. The non-transitory computer-readable storage medium according to claim 1, wherein the control method further comprises:
causing the information processing apparatus to generate print data that causes the printing apparatus to execute the photo correction function with the setting received through the screen in a case where the printing apparatus can execute the photo correction function with the setting received through the screen, and
causing the information processing apparatus to generate print data that is corrected by executing the photo correction function with the setting received through the screen in a case where the printing apparatus cannot execute the photo correction function with the setting received through the screen.

3. The non-transitory computer-readable storage medium according to claim 2, wherein the control method further comprises:
causing the information processing apparatus to generate print data that is corrected by executing the photo correction function with the setting received through the screen in a case where a free space of an image processing memory in the printing apparatus is fewer than a predetermined space even in the case where the printing apparatus can execute the photo correction function with the setting received through the screen.

4. The non-transitory computer-readable storage medium according to claim 3, wherein the predetermined space is a space to which data of an entire image corrected by executing the photo correction function with the setting received through the screen can be developed.

5. The non-transitory computer-readable storage medium according to claim 1, wherein the control method further comprises:
causing the information processing apparatus to display a reception screen to receive a setting about whether to display a preview image;
causing the information processing apparatus to display a preview image of the print data that is corrected by executing the photo correction function with the setting received through the screen in a case where the setting received through the reception screen instructs to display a preview image.

6. The non-transitory computer-readable storage medium according to claim 5, wherein the control method further comprises:
causing the image processing apparatus to pop up the preview image on a displayed screen.

7. The non-transitory computer-readable storage medium according to claim 5, wherein the control method further comprises:
causing the information processing apparatus to display the preview image by incorporating into a displayed screen.

8. The non-transitory computer-readable storage medium according to claim 1, wherein the control method further comprises:
causing the information processing apparatus to display a warning image in a case where the printing apparatus has a function that may conflict with the photo correction function with the setting received through the screen.

9. The non-transitory computer-readable storage medium according to claim 8, wherein the control method further comprises:
causing the image processing apparatus to pop up the warning image on a displayed screen.

10. The non-transitory computer-readable storage medium according to claim 8, wherein the control method further comprises:
causing the information processing apparatus to display the warning image by incorporating into a displayed screen.

11. The non-transitory computer-readable storage medium according to claim 8, wherein the control method further comprises:
causing the printing apparatus to stop the function that may conflict with the photo correction function with the setting received through the screen.

12. A control method that is executed by a computer executing a print application program, which supports a standard driver that is provided by a provider of an operating system and is built in the operating system in advance, the control method comprising:
displaying a screen to receive a setting to a photo correction function that is not provided by the standard driver on an information processing apparatus; and
causing the information processing apparatus to generate print data that can cause a printing apparatus to execute the photo correction function with the setting received through the screen.

13. An information processing apparatus executing a print application program, which supports a standard driver that is provided by a provider of an operating system and is built in the operating system in advance, the information processing apparatus comprising:
a memory device that stores a set of instructions; and
at least one processor that executes the set of instructions to:
display a screen to receive a setting to a photo correction function that is not provided by the standard driver on a display unit; and
generate print data that can cause a printing apparatus to execute the photo correction function with the setting received through the screen.
